(19) United States
(12) Patent Application Publication
(10) Pub. No.: US 2016/0071056 A1
(43) Pub. Date: Mar. 10, 2016

(54) PROGRAMMATICALLY EXECUTING TIME COMPRESSED DELIVERY

(71) Applicant: United Parcel Service of America, Inc., Atlanta, GA (US)

(72) Inventors: David Ellison, Atlanta, GA (US); Robert J. Gillen, Alpharetta, GA (US); Brad Gubler, Atlanta, GA (US)

(21) Appl. No.: 14/664,223

(22) Filed: Mar. 20, 2015

Related U.S. Application Data
(60) Provisional application No. 61/968,457, filed on Mar. 21, 2014.
(60) Provisional application No. 61/978,521, filed on Apr. 11, 2014.

(51) Int. Cl. G06Q 10/08

(52) U.S. Cl. CPC G06Q 10/08355

(57) ABSTRACT

Computer program products, methods, systems, apparatus, and computing entities are provided for determining whether available and executing time compressed/sensitive delivery. In one exemplary embodiment, a method may comprise receiving an electronic notification comprising pick-up locations, delivery locations and a time window, determining whether the items can be picked up at the pick-up locations and delivered to one of the delivery locations within the time window based on available delivery vehicles, available delivery drivers, planned routes, physical vehicle capacity, planned sort capabilities, available meet points, and available pick-up times, and in an instance in which it is determined that the items can be picked up at one of the pick-up locations and delivered to one of the delivery locations within the time window, providing an affirmative response.

### CROSS-REFERENCE TO RELATED APPLICATIONS

This application claims priority to U.S. Provisional Application No. 61/968,457 filed Mar. 26, 2014 and U.S. Provisional Application No. 61/978,521 filed Apr. 11, 2014, both of which are hereby incorporated in their entireties by reference.

### BACKGROUND

With the increased convenience afforded by use of computing devices to shop “on-line,” there is an ever increasing need to reduce delivery time, and as such, new approaches for executing the shipment of items are needed. Through applied effort, ingenuity, and innovation, Applicant has solved many of the problems associated with next-day and same-day delivery by developing a solution that is embodied by the present invention, which is described in detail below.

### BRIEF SUMMARY

In general, embodiments of the present invention provide methods, apparatus, systems, computing devices, computing entities, and/or the like for programmatically executing time compressed/sensitive delivery. In some embodiments, a method may be provided comprising receiving an electronic notification, the electronic notification indicative of a prospective shipment of one or more items, the electronic notification comprising (1) one or more pick-up locations, each indicative of a location that the one or more items are available for pick-up, (2) one or more delivery locations, each indicative of a location at which the one or more items may be delivered, and (3) a time window, determining whether the one or more items can be picked up at one of the one or more pick-up locations and delivered to one of the one or more of delivery locations within the time window based on one or more of available delivery vehicles, available delivery drivers, planned routes, physical vehicle capacity, planned sort capabilities, available meet points, and available pick-up times, and in an instance in which it is determined that the one or more items can be picked up at one of the one or more pick-up locations and delivered to one of the one or more delivery locations within the time window, providing an affirmative response to the electronic notification, the affirmative response indicating that the one or more items can be picked up at one of the one or more pick-up locations and delivered to one of the one or more delivery locations within the time window.

In some embodiments the determination of whether the one or more items can be picked up at one of the one or more pick-up locations and delivered to one of the one or more delivery locations within the time window comprises calculating and determining if at least one vehicle and at least one route can be utilized to pick up one or more items at one of the one or more pick-up locations and deliver the one or more items to one of the one or more delivery locations within the time window.

In some embodiments, the method may further comprise determining whether a need exists for multiple delivery vehicles and delivery routes to pick up one or more items at one of the one or more pick-up locations and deliver the one or more items to one of the one or more delivery locations within the time window.

In some embodiments, the method may further comprise, in an instance in which a single delivery driver and single delivery route is needed, optimizing the single delivery route to pick up one or more items at one of the one or more pick-up locations and deliver the one or more items to one of the one or more delivery locations within the time window.

In some embodiments, the method may further comprise, in an instance in which two or more delivery vehicles are needed to pick up one or more items at one of the one or more pick-up locations and deliver the one or more items to one of the one or more delivery locations within the time window, calculating, for each of the two or more necessary vehicles, an associated delivery route, an associated pick-up time, and an associated pick-up location, the pick-up location for a first vehicle being one of the one or more pick-up locations, the pick-up location for each subsequent driver being a drop-off location for a preceding vehicle, the drop-off location for a last vehicle being one of the one or more delivery locations.

In some embodiments, the method may further comprise coordinating optimization of the associated delivery route of each of the two or more delivery vehicles to determine the associated pick-up time and pick-up location of each of the two or more delivery vehicles, the optimization of the determination being based on (1) existing item delivery constraints of the carrier system and each of the two or more delivery vehicles, and (2) route border limits of each delivery route.

In some embodiments, the method may further comprise allowing a consignor to tender the one or more items at one or more specific time windows within a 24-hour period to facilitate the delivery of the one or more items within time window.

In some embodiments, the method may further comprise providing an affirmative response providing a consignor multiple options to tender the one or more items at one or more specific time windows within a time period to facilitate delivery of the one or more items within the time window.

In some embodiments, the method may further comprise calculating new routes for delivery vehicles using one or more of same day logistics zones, real-time telematics data and synchronized delivery system (SDS) information.

In some embodiments, an apparatus may be provided comprising at least one processor and at least one memory including program code, the at least one memory and the program code configured to, with the processor, cause the apparatus to at least receive an electronic notification, the electronic notification indicative of a prospective shipment of one or more items, the electronic notification comprising (1) one or more pick-up locations, each indicative of a location that the one or more items are available for pick-up, (2) one or more delivery locations, each indicative of a location at which the one or more items may be delivered, and (3) a time window, determine whether the one or more items can be picked up at one of the one or more pick-up locations and delivered to one of the one or more of delivery locations within the time window based on one or more of available delivery vehicles, available delivery drivers, planned routes, physical vehicle capacity, planned sort capabilities, available meet points, and available pick-up times, and in an instance in which it is determined that the one or more items can be picked up at one of the one or more pick-up locations and delivered to one of the one or more delivery locations within the time window, provide an affirmative response to the electronic notification, the affirmative response indicating that the one or more items can be picked up at one of the one or more pick-up locations and delivered to one of the one or more delivery locations within the time window.

In some embodiments, the memory and program code for the determination of whether the one or more items can be picked up at one of the one or more pick-up locations and delivered to one of the one or more delivery locations within the time window is further configured to, with the processor, cause the apparatus to calculate and determine if at least one vehicle and at least one route can be utilized to pick up one or more items at one of the one or more pick-up locations and deliver the one or more items to one of the one or more delivery locations within the time window.

In some embodiments, the memory and program code is further configured to, with the processor, cause the apparatus to determine whether a need exists for multiple delivery vehicles and delivery routes to pick up one or more items at one of the one or more pick-up locations and deliver the one or more items to one of the one or more delivery locations within the time window.

In some embodiments, the memory and program code is further configured to, with the processor, cause the apparatus to in an instance in which a single delivery driver and single delivery route is needed, optimize the single delivery route to pick up one or more items at one of the one or more pick-up locations and deliver the one or more items to one of the one or more delivery locations within the time window.

In some embodiments, the memory and program code is further configured to, with the processor, cause the apparatus to in an instance in which two or more delivery vehicles are needed to pick up one or more items at one of the one or more pick-up locations and deliver the one or more items to one of the one or more delivery locations within the time window, calculate, for each of the two or more necessary vehicles, an associated delivery route, an associated pick-up time, and an associated pick-up location, the pick-up location for a first vehicle being one of the one or more pick-up locations, the pick-up location for each subsequent driver being a drop-off location for a preceding vehicle, the drop-off location for a last vehicle being one of the one or more delivery locations.

In some embodiments, the memory and program code is further configured to, with the processor, cause the apparatus to coordinate optimization of the associated delivery route of each of the two or more delivery vehicles to determine the associated pick-up time and pick-up location of each of the two or more delivery vehicles, the optimization of the determination being based on (1) existing item delivery constraints of the carrier system and each of the two or more delivery vehicles, and (2) route border limits of each delivery route.

In some embodiments, the memory and program code is further configured to, with the processor, cause the apparatus to allow a consignor to tender the one or more items at one or more specific time windows within a 24-hour period to facilitate the delivery of the one or more items within time window. In some embodiments, the memory and program code is further configured to, with the processor, cause the apparatus to provide an affirmative response providing a consignor multiple options to tender the one or more items at one or more specific time windows within a time period to facilitate delivery of the one or more items within the time window. In some embodiments, the memory and program code is further configured to, with the processor, cause the apparatus to calculate new routes for delivery vehicles using one or more of same day logistics zones, real-time telematics data and synchronized delivery system (SDS) information.

In some embodiments, a computer program product may be provided comprising at least one non-transitory computer-readable storage medium having computer-readable program code portions stored therein, the computer-readable program code portions comprising an executable portion configured to receive an electronic notification, the electronic notification indicative of a prospective shipment of one or more items, the electronic notification comprising (1) one or more pick-up locations, each indicative of a location that the one or more items are available for pick-up, (2) one or more delivery locations, each indicative of a location at which the one or more items may be delivered, and (3) a time window, an executable portion configured to determine whether the one or more items can be picked up at one of the one or more pick-up locations and delivered to one of the one or more of delivery locations within the time window based on one or more of available delivery vehicles, available delivery drivers, planned routes, physical vehicle capacity, planned sort capabilities, available meet points, and available pick-up times, and an executable portion configured to, in an instance in which it is determined that the one or more items can be picked up at one of the one or more pick-up locations and delivered to one of the one or more delivery locations within the time window, provide an affirmative response to the electronic notification, the affirmative response indicating that the one or more items can be picked up at one of the one or more pick-up locations and delivered to one of the one or more delivery locations within the time window.

In some embodiments, the executable portion configured to determine whether the one or more items can be picked up at one of the one or more pick-up locations and delivered to one of the one or more delivery locations within the time window comprises an executable portion configured to calculate and determine if at least one vehicle and at least one route can be utilized to pick up one or more items at one of the one or more pick-up locations and deliver the one or more items to one of the one or more delivery locations within the time window.

In some embodiments, the computer program product may further comprise an executable portion configured to determine whether a need exists for multiple delivery vehicles and delivery routes to pick up one or more items at one of the one or more pick-up locations and deliver the one or more items to one of the one or more delivery locations within the time window.

In some embodiments, the computer program product may further comprise an executable portion configured to, in an instance in which a single delivery driver and single delivery route is needed, optimize the single delivery route to pick up one or more items at one of the one or more pick-up locations and deliver the one or more items to one of the one or more delivery locations within the time window.

In some embodiments, the computer program product may further comprise an executable portion configured to, in an instance in which two or more delivery vehicles are needed to pick up one or more items at one of the one or more pick-up locations and deliver the one or more items to one of the one or more delivery locations within the time window, calculate, for each of the two or more necessary vehicles, an associated delivery route, an associated pick-up time, and an associated pick-up location, the pick-up location for a first vehicle being one of the one or more pick-up locations, the pick-up location for each subsequent driver being a drop-off location for a preceding vehicle, the drop-off location for a last vehicle being one of the one or more delivery locations.

In some embodiments, the computer program product may further comprise an executable portion configured to coordinate optimization of the associated delivery route of each of the two or more delivery vehicles to determine the associated pick-up time and pick-up location of each of the two or more delivery vehicles, the optimization of the determination being based on (1) existing item delivery constraints of the carrier system and each of the two or more delivery vehicles, and (2) route border limits of each delivery route. In some embodiments, the computer program product may further comprise an executable portion configured to allow a consignor to tender the one or more items at one or more specific time windows within a 24-hour period to facilitate the delivery of the one or more items within time window.

In some embodiments, the computer program product may further comprise an executable portion configured to provide an affirmative response providing a consignor multiple options to tender the one or more items at one or more specific time windows within a time period to facilitate delivery of the one or more items within the time window. In some embodiments, the computer program product may further comprise an executable portion configured to calculate new routes for delivery vehicles using one or more of same day logistics zones, real-time telematics data and synchronized delivery system (SDS) information.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a carrier/transporter computing entity according to one embodiment of the present invention.

FIG. 3 is an exemplary schematic diagram of a user computing entity according to one embodiment of the present invention.

FIG. 4 is a flowchart illustrating operations and processes that can be used in accordance with various embodiments of the present invention.

FIGS. 5, 6, and 7 are exemplary input and output that can be produced with various embodiments of the present invention.

FIG. 8 is a flowchart illustrating operations and processes that can be used in accordance with various embodiments of the present invention

FIGS. 9A-9E, 10, and 11 are exemplary input and output that can be produced with various embodiments of the present invention.

FIG. 12 is a diagram illustrating logistics zones according to an exemplary embodiment.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY SYSTEM ARCHITECTURE

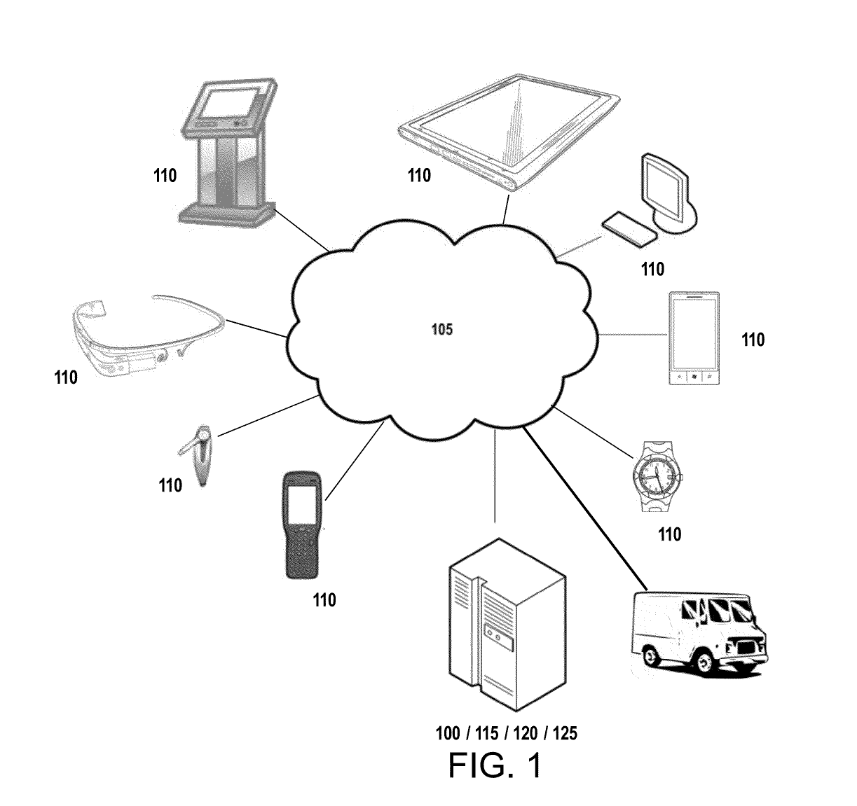

FIG. 1 provides an illustration of an exemplary embodiment of the present invention. As shown in FIG. 1, this particular embodiment may include one or more carrier/transporter computing entities 100, one or more networks 105, one or more user computing entities 110, one or more payment computing entities 115, one or more retailer computing entities 120, one or more social media computing entities 125, and/or one or more mobile entity communications networks (comprising mobile switching centers (MSCs), service control points (SCPs), Home Location Registers (HLRs), Visitor Location Registers (VLRs), and/or the like). Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Exemplary Carrier/Transporter Computing Entity

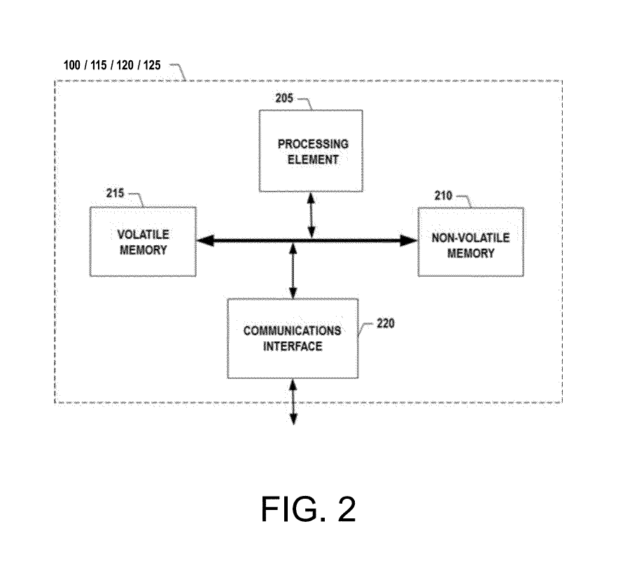

FIG. 2 provides a schematic of a carrier/transporter computing entity 100 according to one embodiment of the present invention. A carrier/transporter may be a traditional carrier/transporter, such as UPS, FedEx, DHL, courier services, the United States Postal Service (USPS), Canadian Post, and/or the like. However, a carrier/transporter may also be a nontraditional carrier/transporter, such as Amazon, Google, Uber, ride-sharing services, crowd-source couriers/services, Macy's, and/or the like. In general, the terms computing entity, computer, entity, device, system, and/or similar words used herein interchangeably may refer to, for example, one or more computers, computing entities, desktops, mobile phones, tablets, phablets, notebooks, laptops, distributed systems, vehicles, gaming consoles (e.g., Xbox, Play Station, Wii), watches, glasses, key fobs, radio frequency identification (RFID) tags, ear pieces, scanners, televisions, vehicles, dongles, cameras, wristbands, wearable items, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. In various embodiments, the term vehicle is used generically. For example, a vehicle may be a manned or an unmanned tractor, truck, car, motorcycle, moped, Segway, bicycle, golf cart, hand truck, cart, trailer, tractor and trailer combination, van, flatbed truck, vehicle, drone, airplane, helicopter, boat, barge, and/or any other form of object for moving or transporting people and/or items (e.g., one or more packages, parcels, bags, containers, loads, crates, items banded together, vehicle parts, pallets, drums, the like, and/or similar words used herein interchangeably). Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

The carrier/transporter computing entity 100 may also comprise, be in communication with, and/or be associated with various other systems, such as an Address Matching System (AMS), an Internet Membership System (IMS), a Customer Profile System (CPS), a Package Center Information System (PCIS), a Customized Pick-up and Delivery System (CPAD), a Web Content Management System (WCMS), a Notification Email System (NES), a Fraud Prevention System (FPS), and a variety of other systems and their corresponding components. The carrier/transporter computing entity 100 may comprise, be in communication with, and/or be associated with various payment networks/systems/entities for carrying out or facilitating the payment of fees. As will be recognized, the payment of such fees may be in a variety of forms, such as via debit cards, credit cards, direct credits, direct debits, cash, check, money order, Internet banking, e-commerce payment networks/systems/entities (e.g., PayPal, Google Wallet, Amazon Payments), virtual currencies (e.g., Bitcoins), award or reward points, and/or the like.

As indicated, in one embodiment, the carrier/transporter computing entity 100 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the carrier/transporter computing entity 100 may include or be in communication with one or more processing elements 205 (also referred to as processors, processing circuitry, and/or similar terms used herein interchangeably) that communicate with other elements within the carrier/transporter computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the carrier/transporter computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the carrier/transporter computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the carrier/transporter computing entity 100 with the assistance of the processing element 205 and operating system.

As indicated, in one embodiment, the carrier/transporter computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the carrier/transporter computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol.

Although not shown, the carrier/transporter computing entity 100 may include or be in communication with one or more input elements, such as a keyboard input, a mouse input, a touch screen/display input, motion input, movement input, audio input, pointing device input, joystick input, keypad input, and/or the like. The carrier/transporter computing entity 100 may also include or be in communication with one or more output elements (not shown), such as audio output, video output, screen/display output, motion output, movement output, and/or the like.

As will be appreciated, one or more of the carrier/transporter computing entity's 100 components may be located remotely from other carrier/transporter computing entity 100 components, such as in a distributed system. Furthermore, one or more of the components may be combined and additional components performing functions described herein may be included in the carrier/transporter computing entity 100. Thus, the carrier/transporter computing entity 100 can be adapted to accommodate a variety of needs and circumstances. As will be recognized, these architectures and descriptions are provided for exemplary purposes only and are not limiting to the various embodiments.

### 2. Exemplary User Computing Entity

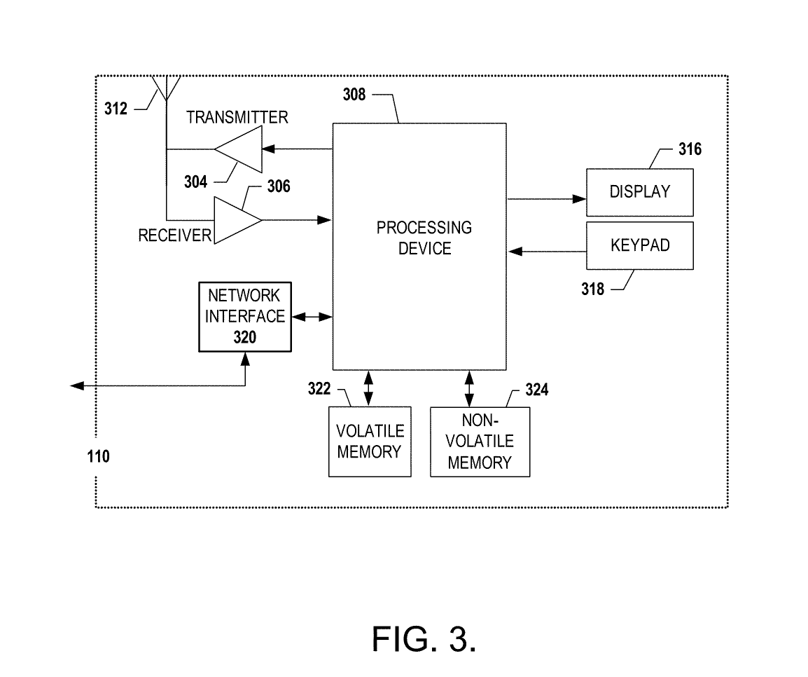

A user may be an individual, a family, a company, an organization, an entity, a department within an organization, a representative of an organization and/or person, and/or the like. To do so, a user may operate a user computing entity 110 that includes one or more components that are functionally similar to those of the carrier/transporter computing entity 100. FIG. 3 provides an illustrative schematic representative of a user computing entity 110 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, RFID tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. As shown in FIG. 3, the user computing entity 110 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the user computing entity 110 may be capable of operating with one or more air interface standards, communication protocols, modulation types, and access types. More particularly, the user computing entity 110 may operate in accordance with any of a number of wireless communication standards and protocols, such as those described above with regard to the carrier/transporter computing entity 100. In a particular embodiment, the user computing entity 110 may operate in accordance with multiple wireless communication standards and protocols, such as UMTS, CDMA2000, 1×RTT, WCDMA, GSM<EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 110 may operate in accordance with multiple wired communication standards and protocols, such as those described above with regard to the carrier/transporter computing entity 100 via a network interface 320.

Via these communication standards and protocols, the user computing entity 110 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 110 can also download changes, add-ons, and updates, for instance, to its firmware, software (e.g., including executable instructions, applications, program modules), and operating system.

According to one embodiment, the user computing entity 110 may include location determining aspects, devices, modules, functionalities, and/or similar words used herein interchangeably. For example, the user computing entity 110 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information can be determined by triangulating the user computing entity's 110 position in connection with a variety of other systems, including wireless towers, Wi-Fi access points, and/or the like. Similarly, the user computing entity 110 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, wireless towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user computing entity 110 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the user computing entity 110 to interact with and/or cause display of information from the carrier/transporter computing entity 100, as described herein. The user input interface can comprise any of a number of devices or interfaces allowing the user computing entity 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the user computing entity 110 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 110. As indicated, this may include a user application that is resident on the entity or accessible through a browser or other user interface for communicating with the carrier/transporter computing entity 100, payment computing entity 115, and/or various other computing entities.

In another embodiment, the user computing entity 110 may include one or more components or functionality that are the same or similar to those of the carrier/transporter computing entity 100, as described in greater detail above. As will be recognized, these architectures and descriptions are provided for exemplary purposes only and are not limiting to the various embodiments.

### 3. Exemplary Payment Computing Entity

In one embodiment, a payment computing entity 115 may include one or more components that are functionally similar to those of the carrier/transporter computing entity 100, the user computing entity 110, the retailer computing entity 120, social media computing entity 125, and/or the like. For example, in one embodiment, each payment computing entity 115 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, the user interface may be a user application, browser, user interface, and/or similar words used herein interchangeably executing on and/or accessible via the payment computing entity 115 to interact with and/or cause display of information from various other entities. As will be recognized, these architectures and descriptions are provided for exemplary purposes only and are not limiting to the various embodiments.

### 4. Exemplary Retailer Computing Entity

In one embodiment, a retailer computing entity 120 may include one or more components that are functionally similar to those of the carrier/transporter computing entity 100, the user computing entity 110, the payment computing entity 115, and/or the social media computing entity 125. A retailer may provide retail services, such as amazon.com, macys.com, dell.com, walmart.com, apple.com, staples.com, amazon.com, bestbuy.com, costco.com, alibaba.com, ebay.com, netflix.com, sears.com, AppleTV, Apple, Dish, Amazon Digital Services, AT&T U-verse, DIRECT TV, Google Play, QVC, Mojang, Blizzard, Capcom, Deepsilver, Zombie Studios, Epic Games, Valve, Carbon Games, Digital Extremes, Klei Entertainment, Riot Games, Frozenbyte, Nvidia Shield, Ouya, Xbox, Xbox 360, Xbox One, Wii, Wii U, PlayStation, PlayStation 2, PlayStation, PlayStation 3, PlayStation 4, 3DO, GameCube, Genesis, Intellivision, Nintendo 64, and/or the like. In one embodiment, each retailer computing entity 120 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, the user interface may be a user application, browser, user interface, and/or similar words used herein interchangeably executing on and/or accessible via the retailer computing entity 120 to interact with and/or cause display of information from various other entities. As will be recognized, these architectures and descriptions are provided for exemplary purposes only and are not limiting to the various embodiments.

### 5 Exemplary Mobile Entity Communications Networks

In one embodiment, the mobile entity communications networks for wireless services may include one or more MSCs, SCPs, VLRs, HLRs, call servers, and/or the like. The mobile entity communications networks may be owned and/or operated by entities, such as China Mobile, Vodafone, Telefonica, T-Mobile, Verizon, AT&T, Qtel, China Unicom, Airtel, Etisalat, and/or the like. The MSCs, SCPs, call servers, and/or the like may include one or more components that are functionally similar to those described above with respect to the carrier/transporter computing entity 100, the user computing entity 110, the payment computing entity 115, and/or the retailer computing entity 120. For example, in one embodiment, entities in the mobile entity communications networks may each include one or more (1) processing elements, (2) memory storage areas, (3) network interfaces, (4) antennae, (5) transceivers, (6) communication interfaces, and/or (7) other components. In one embodiment, although not shown, the MSC 110 may be connected to one or more radio access networks (RAN), including one or more one or more base station controllers (BSC) and one or more base transceiver stations (BTS). As will be recognized, the mobile entity communications networks may support a variety of network types (e.g., wired, wireless, and/or the like) and various communications standards and protocols (e.g., UMTS, CDMA2000, 1×RTT, WCDMA, TD-SCDMA, LTE, E-UTRAN, EVDO, HSPA, HSDPA, Wi-Fi, WiMAX, UWB, Customized Application of Mobile Enhanced Logic (CAMEL), Session Initiation Protocol (SIP), Wireless Intelligent Network (WIN), and/or the like).

### 6. Additional Social Media Computing Entities

In one embodiment, a social media computing entity 125 may include one or more components that are functionally similar to those of the carrier/transporter computing entity 100, the user computing entity 110, the payment computing entity 115, and/or the social media computing entity 125. Social media may include Facebook, LinkedIn, Google+, Pinterest, Microsoft Yammer, WMWare Socialcast, IBM Connections, SalesForce Chatter, Twitter, KaKao Talk, WhatsApp, WeChat, Yo, Etsy, Twitter, Instagram, Vine, Snapchat, YouTube, Qzone, Sina Weibo, Tumblr, LINE, WeChat, Ubisoft, and/or the like. In one embodiment, each social computing entity 125 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, the user interface may be a user application, browser, user interface, and/or similar words used herein interchangeably executing on and/or accessible via the social media computing entity 125 to interact with and/or cause display of information from various other entities. As will be recognized, these architectures and descriptions are provided for exemplary purposes only and are not limiting to the various embodiments.

### III. EXEMPLARY SYSTEM OPERATION

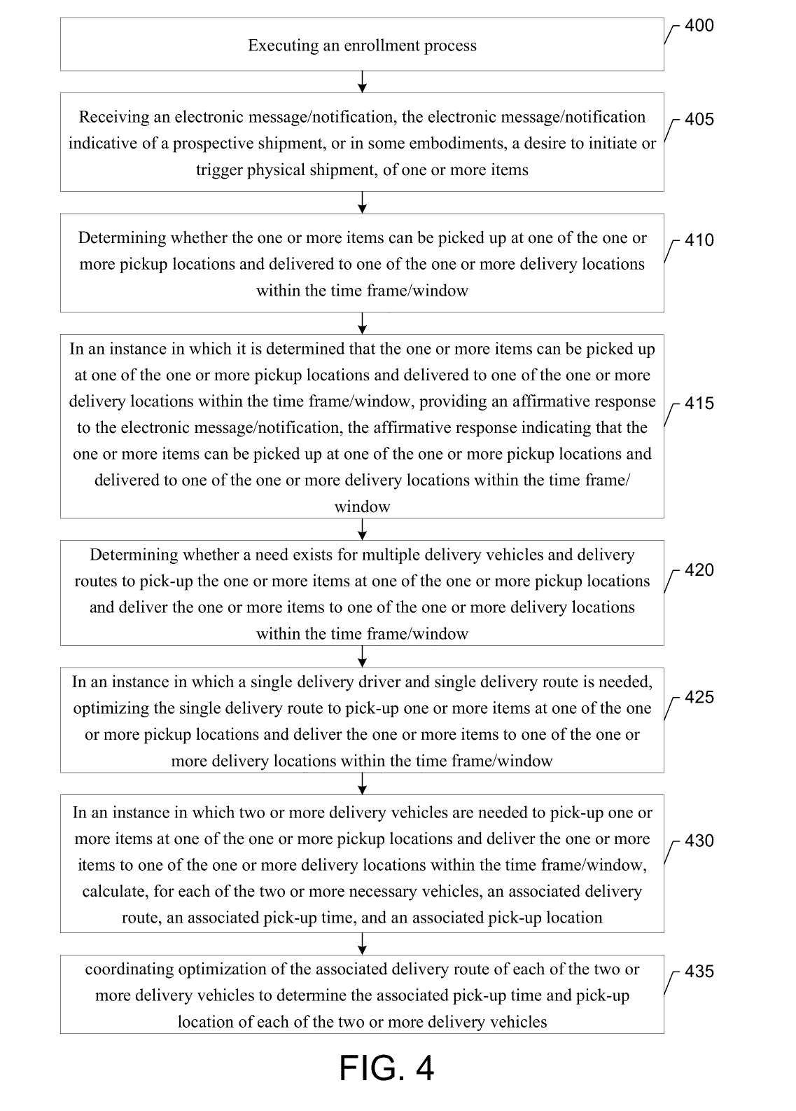

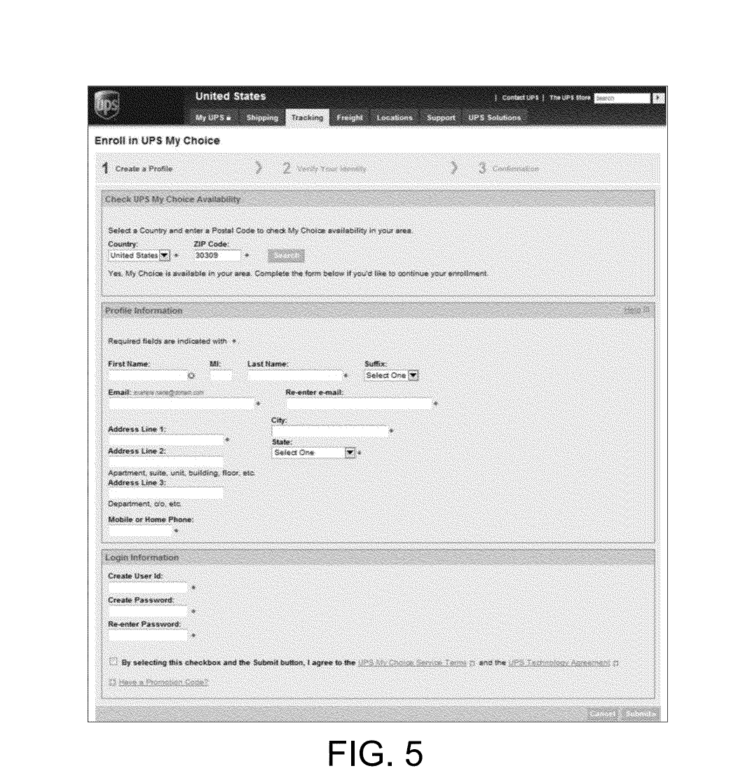

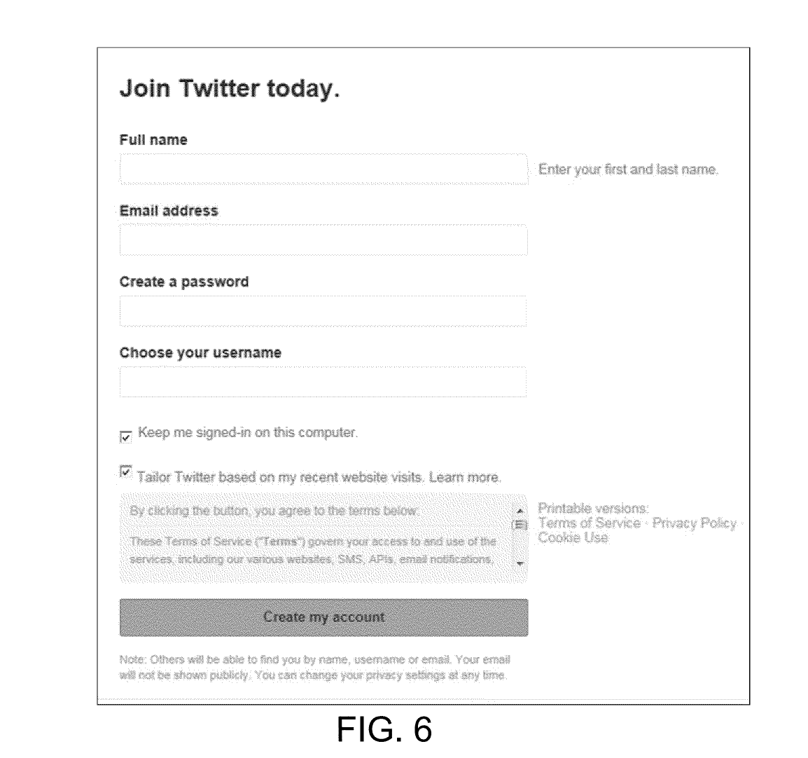

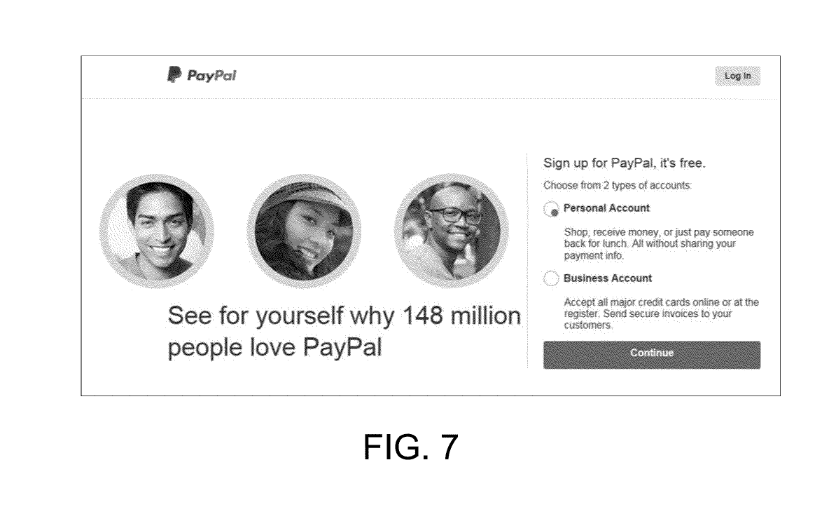

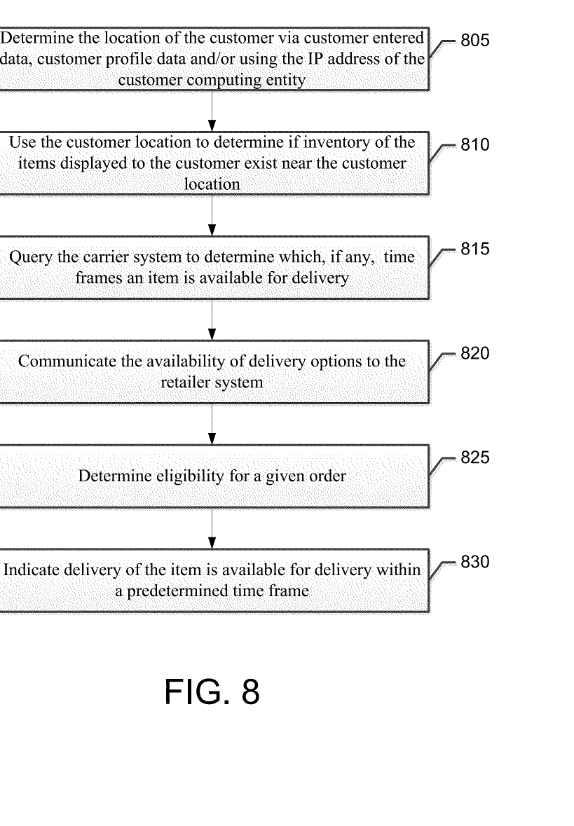

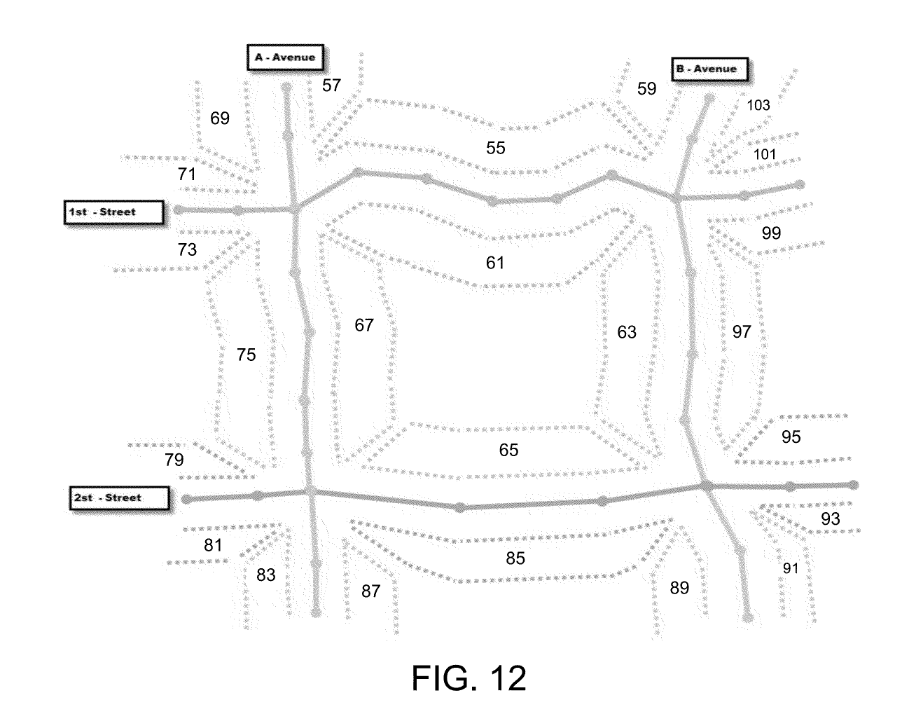

Reference will now be made to FIGS. 4-12. FIGS. 4 and 8 are flowcharts illustrating operations and processes. FIGS. 5, 6, 7, 9A-9E, 10 and 11 are exemplary input and output. And FIG. 12 is a diagram illustrating logistics zones according to an exemplary embodiment.

### 1. Exemplary Registration/Enrollment

In one embodiment, as indicated in Block 400 of FIG. 4, the process may begin with the enrollment/registration for one or more accounts, services, subscriptions, programs, and/or similar words used herein interchangeably (see FIGS. 5, 6, 7). In one embodiment, an account may be an account for wireless services with wireless service providers, such as an account with China Mobile, Vodafone, Telefonica, T-Mobile, Verizon, AT&T, Qtel, China Unicorn, Airtel, Etisalat, and/or the like. An account may be a business or personal social media account, such as an account with Facebook, LinkedIn, Google+, Pinterest, Microsoft Yammer, WMWare Socialcast, IBM Connections, SalesForce Chatter, Twitter, KaKao Talk, WhatsApp, WeChat, Yo, Etsy, Twitter, Instagram, Vine, Snapchat, YouTube, Qzone, Sina Weibo, Tumblr, LINE, WeChat, and/or the like. An account may be a gaming account, such as an account with Ubisoft, Mojang, Blizzard, Capcom, Deepsilver, Zombie Studios, Epic Games, Valve, Carbon Games, Digital Extremes, Klei Entertainment, Riot Games, Frozenbyte, Nvidia Shield, Ouya, Xbox, Xbox 360, Xbox One, Wii, Wii U, PlayStation, PlayStation 2, PlayStation PlayStation 3, PlayStation 4, 3DO, GameCube, Genesis, Intellivision, Nintendo 64, and/or the like. An account may be an entertainment account, such as an account with AppleTV, Apple, Dish, Amazon Digital Services, AT&T U-verse, DIRECT TV, Google Play, QVC, and/or the like. An account may be for retail services, such as an account with amazon.com, macys.com, dell.com, walmart.com, apple.com, staples.com, amazon.com, bestbuy.com, costco.com, alibaba.com, ebay.com, netflix.com, hulu.com, sears.com, and/or the like. An account may be for payment services, such as PayPal, Google Wallet, Amazon Payments, Booker, Erply, Leaf, Leapset, Micros, Revel, ShopKeep, TouchBistro, Apple Pay, Vend, and/or the like. An account may be for pick-up, delivery, and/or returns services with a carrier/transporter entity, such as an account with UPS for My Choice and/or the like. As will be recognized, a variety of different accounts can be used to adapt to various needs and circumstances.

In one embodiment, as part of the enrollment/registration process, a user (e.g., a user or user representative operating a user computing entity 110) may be requested to provide information/data (e.g., including user information/data, biographic information/data, geographic information/data, device or entity information/data, payment information/data, and/or the like). The information/data may be manually input by a user; may be automatically provided by allowing access to other accounts, such as Amazon.com, Facebook, Gmail, Twitter, PayPal, and/or the like; may be automatically collected by various computing entities (including automatic device identification); combinations thereof; and/or other techniques and approaches. For instance, the biographic information/data may include a user ID and/or the user's actual name, such as a first name, a last name, a company name, an entity name, an organization name, and/or the like. As indicated, a user may be an individual, a family, a company, an organization, an entity, a department within an organization, a representative of an organization and/or person, and/or the like. The geographic information/data may also include one or more addresses associated with the user (e.g., street address, city, state, postal code, and/or country). The addresses may be residential or commercial addresses, geocodes, latitude and longitude points, virtual addresses, and/or the like.

In one embodiment, the user information/data may include one or more communication preferences that identify communication formats for communicating with the user. The communication formats may include text messages (e.g., SMS, MMS), email messages, voice messages, video messages (e.g., YouTube, the Vine), picture messages (e.g., Instagram), social media messages (e.g., private social media created internally for entities, business social media (e.g., Yammer, SocialCast), and/or public social media (e.g., Facebook, Instagram, Twitter), emojis, and/or a variety of other messages in various communication formats. In addition to the one or more communication formats, the user (e.g., operating a user computing entity 110) can provide the corresponding electronic destination addresses or user IDs to be used in providing information/data associated with the notification/message services to the user (e.g., email addresses, online handles, phone numbers, usernames, user IDs, etc.). For instance, for text messages, the user may provide one or more wireless phone numbers. For email messages, the user may provide one or more email addresses. And for voice messages, the user may provide one or more wireless or landline phone numbers or other electronic destination addresses to which audio files can be delivered. Additionally, in one embodiment, validation operations can be performed with respect to each input electronic destination address—to ensure accuracy. As will be recognized, a variety of other types of electronic destination addresses can be used to adapt to various needs and circumstances.

In certain embodiments, the user (e.g., a user or user representative operating a user computing entity 110) may be requested to provide payment information/data. As indicated, payments (e.g., the payment information/data) may be in a variety of forms, such as via debit cards, credit cards, direct credits, direct debits, cash, check, money order, Internet banking, e-commerce payment networks/systems (e.g., PayPal, Google Wallet, Amazon Payments), virtual currencies (e.g., Bitcoins), award or reward points, and/or the like. Such payments may be made using a variety of techniques and approaches, including through NFC technologies such as PayPass, Android Beam, S Beam, BLE, and various other contactless payment systems. Further, such payment technologies may include PayPal Beacon, Booker, Erply, Leaf, Leapset, Micros, PayPal Here, Revel, ShopKeep, TouchBistro, Apple Pay, Vend, and/or the like.

In one embodiment, device or entity information/data may also be received, provided, detected, assigned, collected, requested, and/or similar words used herein interchangeably as part of the registration/enrollment process. The device or entity information/data may include one or more entity or device identifiers—phone numbers, Subscriber Identity Module (SIM) numbers, Media Access Control (MAC) addresses, International Mobile Subscriber Identity (IMSI) numbers, Internet Protocol (IP) addresses, Mobile Equipment Identifiers (MEIDs), unit identifiers (e.g., GPS unit identifiers, Unique Device Identifiers (UDiDs), mobile identification numbers (MINs), IMSI_S (Short IMSIs), email addresses, usernames, user IDs, Globally Unique Identifiers (GUIDs), Integrated Circuit Card Identifiers (ICCIDs), electronic serial numbers (ESN), International Mobile Equipment Identities (IMEIs), Wi-Fi IDs, RFID tags, and/or the like. The device or entity information/data may include a device's vendor, model, specification authority, version, components, software specification and/or version, person associated with the device, and/or the like. The device or entity information/data may be used to communicate with and/or verify communications to and from the corresponding devices or entities.

In one embodiment, with the appropriate information/data, an appropriate computing entity (e.g., carrier/transporter computing entity 100, user computing entity 110, payment computing entity 115, retailer computing entity 120, social media computing entity 125, mobile entity communications network) may create or update an account with a user profile for the user via the enrollment/registration process. Accordingly, an appropriate computing entity (e.g., carrier/transporter computing entity 100, user computing entity 110, payment computing entity 115, retailer computing entity 120, social media computing entity 125, mobile entity communications network) may create, store, update, and/or have access to various accounts/user profiles and/or information/data associated with the accounts/user profiles. In addition to at least the information/data described above, each account/user profile may include one or more corresponding usernames, passwords, images, tokens, challenge phrases, reminders, and/or the like (referred to herein as credentials) for accessing accounts/user profiles, applications, services, entities, and/or the like.

As will be recognized, in one embodiment, the user (e.g., operating a user computing entity 110) may provide or allow access to the information/data for the user's contacts, connections, associations, friends, links, followers, and/or similar words used herein interchangeably. The information/data for the user's contacts may be stored by the user's computing entity 115 and/or by various other computing entities. In one embodiment, with access to the information/data for the user's contacts, an appropriate computing entity (e.g., carrier/transporter computing entity 100, user computing entity 110, payment computing entity 115, retailer computing entity 120, social media computing entity 125, mobile entity communications network) can carry out or facilitate carrying actions involving the same.

### 2. Time Compressed/Sensitive Delivery

In some embodiments, for example, as part of the online shopping experience, a payment computing entity 115, retailer computing entity 120, social media computing entity 125 or the like may send a request to the carrier/transporter computing entity 100 to determine/identify whether same-day delivery, next-day delivery and/or other time compressed/sensitive delivery options (e.g., within the next 2, 4, or 6 hours) are available. The term time compressed/sensitive delivery, as referred to herein, describes a process combining the execution capabilities provided by an existing information network with the capabilities of predictive analytics and physical logistics optimization, or near optimization, to deliver items in a time sensitive manner. An item may be any tangible and/or physical object. In one embodiment, an item may be or be enclosed in one or more packages, parcels, bags, containers, loads, crates, items banded together, vehicle parts, pallets, drums, the like, and/or similar words used herein interchangeably. Such items may include the ability to communicate (e.g., via a chip (e.g., an integrated circuit chip), RFID, NFC, Bluetooth, Wi-Fi, and any other suitable communication techniques, standards, or protocols) with one another and/or communicate with various computing entities for a variety of purposes. In this regard, in some example embodiments, an item may communicate send “to” address information/data, received “from” address information/data, unique identifier codes, and/or various other information/data. In one embodiment, each item may include an item/shipment identifier, such as an alphanumeric identifier. Such item/shipment identifiers may be represented as text, barcodes, tags, character strings, Aztec Codes, MaxiCodes, Data Matrices, Quick Response (QR) Codes, electronic representations, and/or the like. A unique item/shipment identifier (e.g., 123456789) may be used by the carrier to identify and track the item as it moves through the carrier's transportation network. Further, such item/shipment identifiers can be affixed to items by, for example, using a sticker (e.g., label) with the unique item/shipment identifier printed thereon (in human and/or machine readable form) or an RFID tag with the unique item/shipment identifier stored therein.

To facilitate a purchase transaction for a time compressed/sensitive delivery, a customer (e.g., a customer or customer representative operating a user computing entity 110) may access a webpage or portal of an online merchant. For instance, the retailer computing entity 120 may provide an interface (e.g., browser, dashboard, application from a carrier/transporter and/or retailer) providing the customer with an online store front that allows the customer to browse and select one or more items for purchase. The purchase transaction may be facilitated using a shopping cart or other technique, which allows a customer to accumulate a list of items for purchase. In some embodiments, it may be desirable to the customer (e.g., a customer or customer representative operating a user computing entity 110) or to the retailer (e.g., the retailer computing entity 120) to know what delivery options exists and/or whether time compressed/sensitive delivery is available before, during, and/or after purchase. For example, FIG. 8 shows an example display 800 that may be presented by a display screen of a device, such as those used by a user (e.g., a customer, consignee, consignor, retailer, or the like) which as described above, may be referred to herein as a user computing entity 110. As is shown, display 800 shows an exemplary on-line merchant-provided interface (e.g., a webpage displayed in, for example, an internet browser) comprising items available for purchase (e.g., jeans). As is further shown, a number of the items comprise indications of the availability of time-compressed delivery. For example, the text “This item is Next Day eligible. Order by 9 PM and receive this item tomorrow for $5” appears with three of the items. Note that the portion of the displays described herein may be labeled differently and not necessarily as shown.

Now, referring back to FIG. 4, which shows a flowchart illustrating a process that may be performed by a carrier/transporter computing entity 100 to determine/identify whether time compressed/sensitive delivery is available and, in the event time compressed/sensitive delivery is available, execute time compressed/sensitive delivery, a carrier/transporter computing entity 100 (e.g., in communication with a user computing entity 110, a payment computing entity 115, a retailer computing entity 120, a social media computing entity 125, or the like), as is shown in operation 405, may include means, such as processor 205 or the like, for receiving an electronic message/notification, the electronic message/notification indicative of a prospective shipment, or in some embodiments, a desire to initiate or trigger physical shipment, of one or more items.

The term “electronic message/notification” as used herein, may include an order of a product or service on a e-commerce platform provided by, for example, retailer computing entity 120 via, any method or process enabled by the retailer computing entity (e.g., add-to-cart or the like) and/or purchase (Amazon's 1-click ordering, checkout and pay, etc.). The term “electronic message/notification” as used herein, may also include messages or the like sent via a social media computing entity 125, for example, intending or functioning as an order or purchase of a product or service. The electronic message/notification may comprise one or more pick-up locations, each indicative of a location that the one or more items are available for pick-up, one or more delivery locations, each indicative of a location at which the one or more items may be delivered, and a time frame/window, the time frame/window indicative of when the one or more items should be delivered by. In some embodiments, the carrier/transporter computing entity 100 may include means, such as processor 205 or the like, for, allowing a consignor to tender the one or more items at one or more specific time frames/windows within, for example, a 24-hour period to facilitate the delivery of the one or more items within the time frame/window (e.g., by 8 p.m. for next-day delivery, by 8 a.m. for same-day delivery or the like).

As customers browse for items to purchase, the retailer system may, in some embodiments, communicate with the carrier/transporter computing entity 100 (e.g., by sending the electronic message/notification indicative of a prospective shipment) to receive an indication of whether time-compressed delivery is available or, in other embodiments, utilize the customer location without having to communicate with the carrier/transporter computing entity 100. For example, the carrier/transporter computing entity 100 may be configured to establish rules with, for example, any of a payment computing entity 115, a retailer computing entity 120, a social media computing entity 125, or the like, for enabling the determination of whether time-compressed delivery is available within predetermined time frames. For example, delivery within 24 hours may be available for orders within a given geographic area and/or received by a predetermined and/or agreed upon time. In some embodiments, the given geographic area and/or the predetermined time may be item dependent. For example, items under a certain weight (e.g., 25 lbs.) may be available for same day delivery if ordered by a certain time (e.g., 2 pm). In any event, each of the pre-established rules may be stored locally in, for example, any of a payment computing entity 115, a retailer computing entity 120, a social media computing entity 125, or the like. To utilize the pre-established rules, a payment computing entity 115, a retailer computing entity 120, a social media computing entity 125, or the like may be configured to determine if inventory of the items displayed to the customer are available near the customer location. That is, in some embodiments, the retailer computing entity 120 may be configured for determining whether an item (e.g., a currently displayed item) is available for delivery to the customer location. For example, in some embodiments, the retailer computing entity 120 may be configured to determine a location of the customer (e.g., customer profile, GPS, triangulation, or the like) and if the item is located within a predetermined distance of the location of the customer.

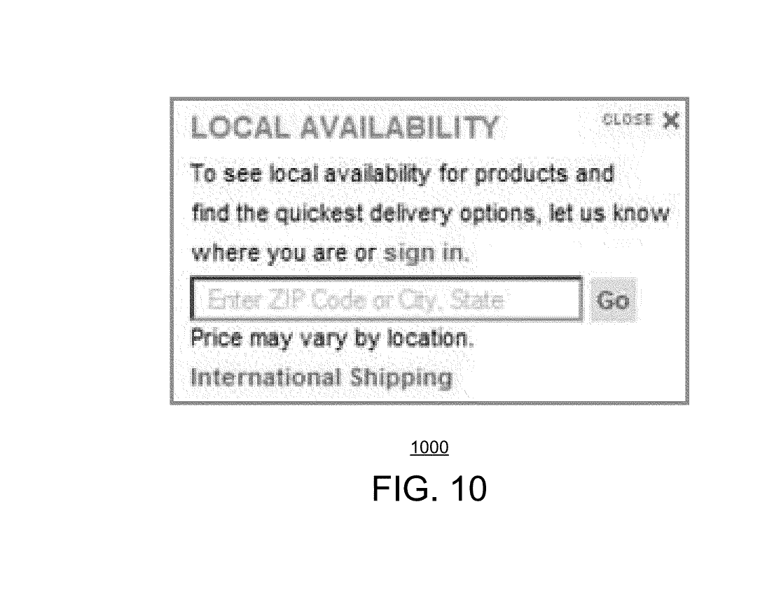

In some embodiments, the electronic message/notification may be received from a user account with, for example, the carrier/transporter computing entity 100 or a user account with a payment computing entity 115, a retailer computing entity 120, a social media computing entity 125, or the like. In some embodiments, the accounts may be linked, joined, or otherwise associated. For example, an account with a retailer (e.g., macys.com), a social media account (e.g., Twitter), an account with a carrier/transporter (e.g., UPS My Choice), or a wireless service account (e.g., Verizon), and/or the like may be associated. Further, in other embodiments, an appropriate computing entity may be able to create a new account/user profile based on information/data for an existing account. For example, for a user with an account with the carrier/transporter entity, the carrier/transporter computing entity 100 can create a social media account for the corresponding user with the user's information/data. For instance, John Doe may have an account with UPS (username: JohnDoe899; password: *********). The carrier/transporter computing entity 100 (e.g., UPS) can automatically register John Doe for a social media account with the social media computing entity 125 (e.g., Twitter) and connect, link, and/or associate the accounts (See FIG. 10). By being connected, linked, and/or associated, information/data can be shared between the various entities to carry out various actions.

Once the electronic message/notification is received, a determination of whether the one or more items can be picked up at one of the one or more pick-up locations and delivered to one of the one or more delivery locations within the time frame/window may be made. In some embodiments, a determination of whether pick up of the item from the retailer, or other designated location (e.g., local store/distribution center) may be made, for example, during normal pick-up/delivery times, on a planned and/or previously scheduled route. Whereas, in some embodiments, a determination of whether pick up of the item from the retailer, or other designated location (e.g., local store/distribution center) may be made on an re-configured route while, for example, maintaining existing item delivery constraints. Similarly, in some embodiments, a determination of whether delivery of the item may be made, for example, during normal pick-up/delivery times, on a planned and/or previously scheduled route. And, in some embodiments, a determination of whether delivery of the item may be made on a re-configured route while, for example, maintaining existing item delivery constraints.

As such, as shown in operation 410, carrier/transporter computing entity 100 (e.g., in communication with a user computing entity 110, a payment computing entity 115, a retailer computing entity 120, a social media computing entity 125, or the like), may include means, such as processor 205 or the like, for determining whether the one or more items can be picked up at one of the one or more pick-up locations and delivered to one of the one or more delivery locations within the time frame/window. In some embodiments, the carrier/transporter computing entity 100 may include means to receive information indicative of, or in some embodiments, identify the one or more pick-up locations based on the one or more delivery locations. For example, each of the one or more pick-up locations may be local retailer locations, warehouses, storage facilities or the like, each identified based on a proximity to one of the one or more delivery locations. As will be understood by those skilled in the art, many online merchants have multiple fulfillment centers or drop-ship locations distributed throughout a geographic area from which an order may be fulfilled. A carrier/transporter may consider time-in-transit information from each fulfillment center or drop-ship location to different geographic areas (e.g., zip codes, cities, states, regions, etc.) and/or logistics zones as described in detail herein. Of course, if the online merchant has a single fulfillment center or drop-ship location, time-in-transit information would be considered for that single location.

In some embodiments, the carrier/transporter computing entity 100 may include means, such as processor 205 or the like, for analyzing dynamic data relating to prospective shipments (e.g., shipments with a forecasted delivery date, a scheduled shipment, a planned delivery, or the like) and/or virtual items. In various embodiments, the dynamic data may include data for prospective shipments and may include a ship date, one or more pick-up locations (e.g., an origin address), one or more delivery locations (e.g., a destination address), time frame/window and/or a service level. Using this information, a carrier/transporter may determine whether the prospective shipment could be synchronized with one or more shipments already forecasted for delivery to one of the one or more delivery locations or nearby locations. For example, in various embodiments, delivery address profiles may be established. The delivery address profile data may link a particular address to other nearby addresses (e.g., a close residential address, same neighborhood, commercial addresses within the same building, an apartment complex, duplex, along the same route, etc.). This linking may relate to a service point, which identifies where a service provider may stop to service one or more addresses. For example, a service provider may make a single stop (e.g., at a service point) to make deliveries to multiple address (or a single address) such as an apartment complex or shopping mall. The delivery address profile may include a list of consignees receiving items at the address, frequency of deliveries to or pick-ups from the address and/or nearby addresses (e.g., average daily volume, average weekly stops), typical days of delivery and/or pick-up (e.g., Monday, Tuesday, Wednesday, etc.), costs associated with making a delivery to the address and/or nearby addresses, whether deliveries require consignee signatures or allow driver release, delivery type (e.g., residential or commercial), and stop reputation for the associated addresses or nearby addresses. The stop reputation may include data regarding missed deliveries, claims, delinquencies, etc. Additional information may include business names, suite, floor, building, apartment number, and the like.

In addition to the delivery address profile, a pick-up location profile may also be created. The pick-up location profile may include characteristics of the fulfillment or drop ship location as well as the consignor. The pick-up location profile data may link a particular address to other nearby addresses (e.g., a close residential address, commercial addresses within the same building, an apartment complex, duplex, along the same route, etc.). The pick-up location profile may include a list of consignors sending shipments from the address, frequency of deliveries to or pick-ups from the address and/or nearby addresses (e.g., average daily volume, average weekly stops), typical days of delivery and/or pick-up (e.g., Monday, Tuesday, Wednesday, etc.), costs associated with making a pick-up from the address and/or nearby addresses, delivery type (e.g., residential or commercial), and stop reputation for the associated addresses and/or nearby addresses. The stop reputation may include data regarding missed pick-ups, claims, delinquencies, etc. Additional information may include business names, suite, floor, building, apartment number, and the like. Further discussion of synchronized shipments, pick-up locations profiles and delivery address profiles may be found in U.S. application Ser. No. 13/828,652 entitled “Systems and Methods for Synchronized Delivery” filed on Mar. 14, 2013, which is hereby incorporated by reference.

In some embodiments, the carrier/transporter computing entity 100 may include means, such as processor 205 or the like, for determining a cost associated with time compressed/sensitive delivery based on, for example, the pick-up locations, the delivery locations, the time frame/window, a size or amount of items, any special handling instructions or the like. For example, those items that may be larger, those that may require special handling or the like may have an increased associated cost.

The determination may be based on one or more available delivery vehicles, available delivery routes, and available pick-up times. In some embodiments, the determination may be made by calculating and/or determining if at least one vehicle and at least one route can be utilized to pick up one or more items at one of the one or more pick-up locations and deliver the one or more items to one of the one or more delivery locations within the time frame/window. In other embodiments, depending on the time/frame window, independent determinations may be made whether at least one vehicle may be utilized to pick up one or more items at one of the one or more pick-up locations within a particular time frame/window (e.g., the same day as the request) and whether at least one vehicle may be utilized to deliver the one or more items at one of the one or more delivery locations within the time frame/window. Additionally or alternatively, in some embodiments, a determination may be made whether the delivery of the one or more items may involve, may require, or otherwise may be made utilizing at least one sort, for example, at a sorting facility. For example, the one or more items may be picked up at one of the one or more locations by a vehicle on, for example, a planned route, and dropped off at a sorting facility. Delivery may then still be made within the particular time frame/window. In some embodiments, a pre-defined amount of time may be dedicated to time spent at a sorting facility or the like.

The carrier/transporter computing entity 100 (e.g., in communication with a user computing entity 110, a payment computing entity 115, a retailer computing entity 120, a social media computing entity 125, or the like), as shown in operation 415, may include means, such as processor 205 or the like, for, in an instance in which it is determined that the one or more items can be picked up at one of the one or more pick-up locations and delivered to one of the one or more delivery locations within the time frame/window, providing an affirmative response to the electronic message/notification, the affirmative response indicating that the one or more items can be picked up at one of the one or more pick-up locations and delivered to one of the one or more delivery locations within the time frame/window. In some embodiments, the carrier/transporter computing entity 100 may include means, such as processor 205 or the like, for providing an affirmative response indicating one or more same-day or time-compressed shipping options. For example, in some embodiments, the carrier/transporter computing entity 100 may include means, such as processor 205 or the like, for providing an affirmative response providing a consignor one or more options to tender the one or more items at one or more specific time windows within a duration (e.g., a 24-hour period) to facilitate delivery of the one or more items within the time window. In some embodiments, the carrier/transporter computing entity 100 may include means, such as processor 205 or the like, for calculating the one or more specific time windows such that the one or more items may be picked up, sorted at, for example, a sorting facility associated or a part of the carrier system, and subsequently delivered.

Once the determination has been made, purchase of one or more items made, etc., the carrier/transporter computing entity 100 may then implement the time compressed/sensitive delivery. In some embodiments, the carrier/transporter computing entity 100 may be configured for utilizing the logistics zones to facilitate pick-up and/or delivery of items. For example, exemplary embodiments may utilize the logistics zones to determine an optional travel route for each of one or more available vehicles on a delivery route to coordinate pick-up and/or delivery of items in the logistics zones. In addition, exemplary embodiments may determine the planned travel miles for available routes, the planned travel time for each route, as well as other suitable shipping data. The carrier/transporter computing entity 100 may further be configured generating a planned travel route (or “planned route”) for pick-up and/or delivery of items within the logistics zones based in part on a determined trace order of the logistics zones specifying a sequential order in which to travel within the logistics zones in response to determining a shortest travel path. While any method of route selection and/or optimization may be used to implement the process herein, the operations below will be exemplified with reference to logistics zones, which are further described in detail in U.S. application Ser. No. 13/964,766 entitled “Methods, Apparatuses, and Computer Program Products for Generating Logistics Zones” filed on Aug. 12, 2013, and is hereby incorporated by reference.

As is shown in operation 420, the carrier/transporter computing entity 100 (e.g., in communication with a user computing entity 110, a payment computing entity 115, a retailer computing entity 120, a social media computing entity 125, or the like), as shown in operation 415, may include means, such as processor 205 or the like, for determining whether a need exists for multiple delivery vehicles and/or delivery routes to pick up the one or more items at one of the one or more pick-up locations and deliver the one or more items to one of the one or more delivery locations within the time frame/window. For example, where a single vehicle, for example, operating on a planned route, may not be able to pick up the one or more items at the one of the one or more pick-up locations and deliver the one or more items to one of the one or more delivery locations within the time frame/window, the carrier/transporter computing entity 100 may be configured to, based on currently available vehicles, dynamically identify, create, insert or the like, meet-up points and/or meet-up times in the planned routes of one or more available vehicles to execute, for example, same-day, delivery. For example, in an instance in which a pick-up location is at a first location (e.g., First Avenue) and the delivery location is at a second location (e.g., Twelfth Avenue), the carrier/transporter computing entity 100 may be configured to, based on currently available vehicles (e.g., the vehicles identified as being associated with routes that include the second location), dynamically identify and/or insert an intermediate point (e.g., Fifth Avenue) and a meet-up time in each vehicle's planned route such that both vehicles are able to arrive at the intermediate point at the meet-up time, exchange the one or more items, and, for example, still maintain their other delivery obligations. That is, the carrier/transporter computing entity 100 may be configured to dynamically optimize, alter, or re-configure the planned route of each vehicle such that the one or more items may picked-up at one of the one or more pick-up location and delivery to one of the one or more delivery locations within the time frame/window.

In some embodiments, the carrier/transporter computing entity 100 (e.g., in communication with a user computing entity 110, a payment computing entity 115, a retailer computing entity 120, a social media computing entity 125, or the like) may include means, such as processor 205 or the like, for determining whether the one or more items can be picked up at one of the one or more pick-up locations and delivered to one of the one or more delivery locations within the time window based on one or more of (1) available delivery vehicles, (2) available delivery drivers, (3) planned routes, (4) physical vehicle capacity, (5) planned sort capabilities, (6) available meet points, (7) available pick-up times, or the like. In some embodiments, in addition to considering and/or determining transport logistics, the carrier/transporter computing entity 100 may include means, such as processor 205 or the like, for determining whether the item requested by the consignee is available, a location at which the item is available, and if the item can be picked up by a delivery vehicle on a planned route by a scheduled driver. In other embodiments, the carrier/transporter computing entity 100 may include means, such as processor 205 or the like, for determining whether the item can be picked up by any delivery vehicle, such as for example, on a re-configured route.

In some embodiments, the carrier/transporter computing entity 100 may be configured for calculating new routes for delivery vehicles and, in some embodiments, drivers, using, for example, same-day/time-compressed logistics zones, real-time telematics data and/or synchronized delivery system (SDS) information. As is shown in operation 425, the carrier/transporter computing entity 100 (e.g., in communication with a user computing entity 110, a payment computing entity 115, a retailer computing entity 120, a social media computing entity 125, or the like), as shown in operation 415, may include means, such as processor 205 or the like, for, in an instance in which a single delivery driver and single delivery route is needed, optimizing, altering, or re-configuring a planned route such that the single delivery driver operating on the single delivery route is able to pick up one or more items at one of the one or more pick-up locations and deliver the one or more items to one of the one or more delivery locations within the time frame/window. As described above, in some embodiments, the carrier/transporter computing entity 100 may be configured to utilize the logistics zones to determine an optional travel route to coordinate pick-up and/or delivery of items in the logistics zones, and then, subsequently, in some embodiments, determine the planned travel miles and/or planned travel time for each route, and finally, in some embodiments, generate a travel route for pick-up and/or delivery of items within the logistics zones, for example, specifying a sequential order in which to travel within the logistics zones in response to determining a shortest travel path.

As is shown in operation 430, the carrier/transporter computing entity 100 (e.g., in communication with a user computing entity 110, a payment computing entity 115, a retailer computing entity 120, a social media computing entity 125, or the like), as shown in operation 415, may include means, such as processor 205 or the like, for, in an instance in which two or more delivery vehicles are needed to pick up one or more items at one of the one or more pick-up locations and deliver the one or more items to one of the one or more delivery locations within the time frame/window, calculate, for each of the two or more necessary vehicles, an associated delivery route, an associated pick-up time, and an associated pick-up location. In some embodiments, the pick-up location for a first vehicle may be one of the one or more pick-up locations, the pick-up location for each subsequent driver being a drop-off location for a preceding vehicle, the drop-off location for a last vehicle being one of the one or more delivery locations. For example, the carrier/transporter computing entity 100 may be configured to dynamically identify and/or create meet-up points and/or meet-up times for one or more available vehicles to coordinate pick-up and/or delivery of items in, for example, the logistics zones. Moreover, as described above, in some embodiments, the planned travel miles and/or planned travel time for each route may be calculated and, in some embodiments, a travel route for pick-up and/or delivery of items within the logistics zones may be generated.

As is shown in operation 435, the carrier/transporter computing entity 100 (e.g., in communication with a user computing entity 110, a payment computing entity 115, a retailer computing entity 120, a social media computing entity 125, or the like), as shown in operation 415, may include means, such as processor 205 or the like, for coordinating optimization of the associated delivery route of each of the two or more delivery vehicles to determine the associated pick-up time and pick-up location of each of the two or more delivery vehicles, the optimization of the determination being based on (1) existing item delivery constraints of the carrier/transporter system and each of the two or more delivery vehicles; and (2) route/location border limits of each delivery route.

### 3. Enhanced Delivery Time/Window Concepts

In some embodiments, an interface (e.g., browser, dashboard, application from a carrier and/or retailer) in communication with the carrier system 100 and/or retailer system/third party system 125 can be used to automatically provide and receive selection of, for example, one or more expected, estimated, confirmed, and/or guaranteed pickup or delivery times (including pickup or delivery windows). For example, a customer (e.g., a customer or customer representative operating a consignee computing entity 110 or consignor computing entity 120) may access the interface (e.g., browser, dashboard, application from a carrier and/or retailer) in communication with the carrier system 100 and/or retailer system/third party system 125, while for example, shopping online via the retailer's website, application, or the like, to view an item and one or more expected, estimated, confirmed, and/or guaranteed pickup or delivery times for the item, before, during, and/or after purchase. Furthermore, in some embodiments, the interface (e.g., browser, dashboard, application from a carrier and/or retailer) in communication with the carrier system 100 and/or retailer system/third party system 125 can be used to automatically provide and receive selection of, for example, one or more access points, for example, to which delivery can be made based on the customer location, the one or more access points being staffed (e.g., (a “brick and mortar” store or the like) or unstaffed (e.g., a “drop box” or the like). Similar to the pickup or delivery times, the access point(s) may be provided and/or viewed before, during, and/or after purchase. In some embodiments, item location and/or other item characteristics (e.g., size, special handling instructions or the like) may factor into the determination of the one or more access points.

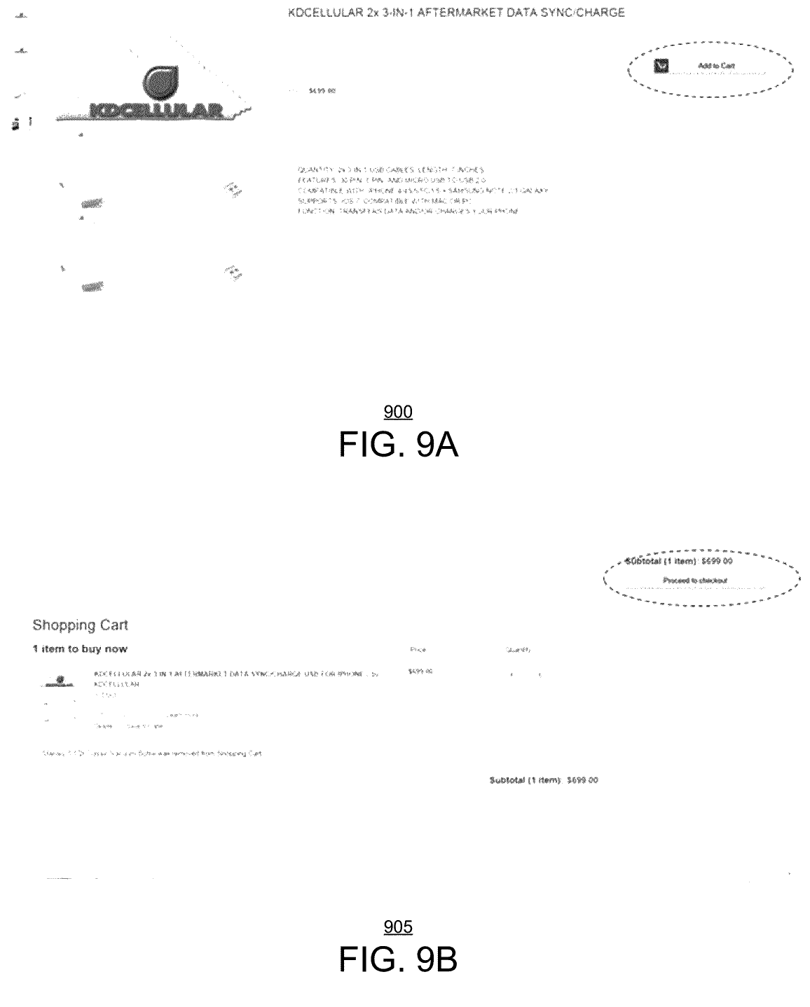

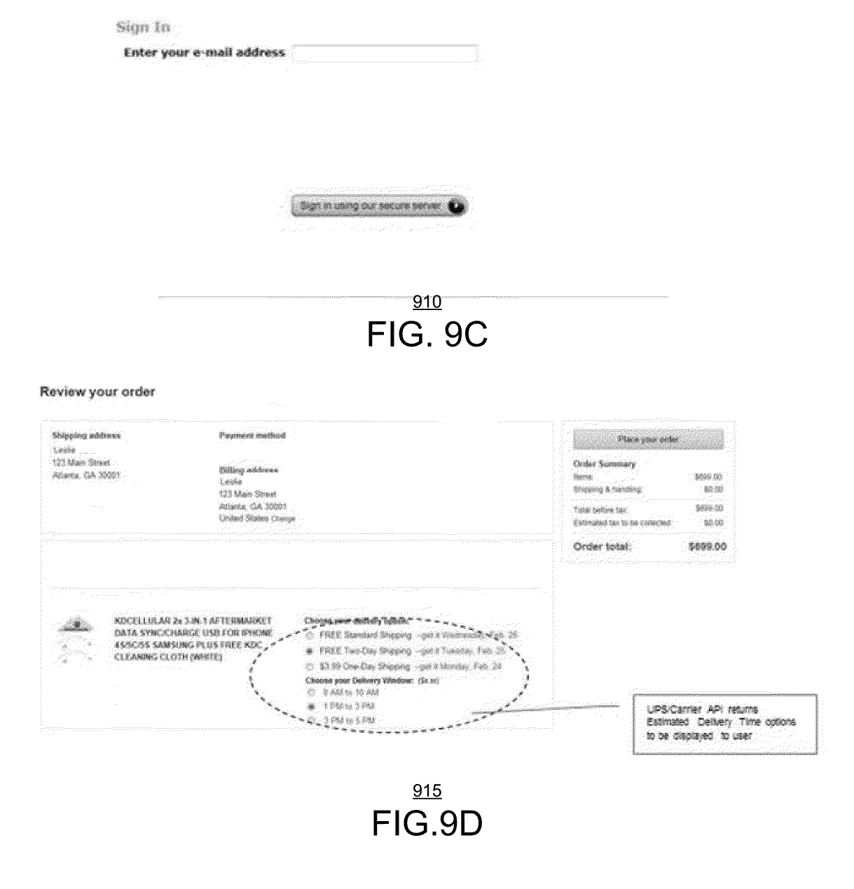

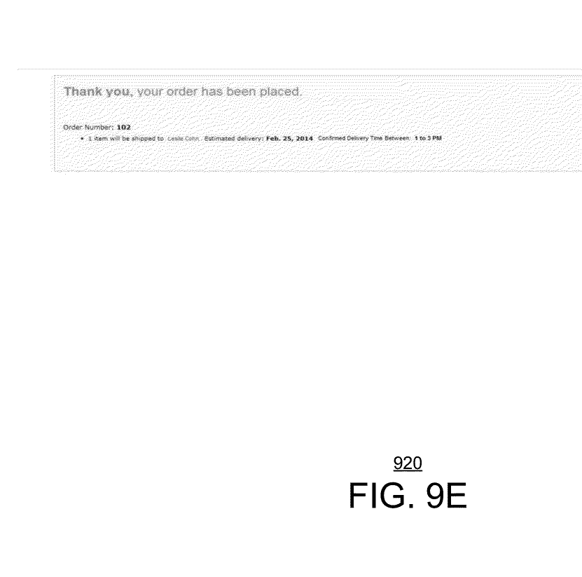

FIG. 8 shows a flowchart illustrating a process that may be performed by a retailer system/third party system 125 and/or a carrier system 100 for providing one or more delivery benefits to, for example, authenticated users as well as non-authenticated users, including but are not limited to, providing one or more delivery windows for selection, to online shoppers utilizing one of the retailer's website (e.g., www.retailer.com), a retailer login API, and/or a carrier API (e.g., Carrier Accelerated Program Enrollment API). The flowchart shown in FIG. 8 will be described with reference to example displays 900-950 shown in FIGS. 9A-9E. FIGS. 9A-9E show example displays 900-950 that may be presented by one or more display screens of one or more devices, such as those used by a user, such as a customer, consignee, consignor, retailer, or the like, which as described above, may be referred to herein as a consignee computing device 110 or consignor computing entity 120. While the example displays 9A-9E are configured to be shown on a computer monitor, laptop screen, tablet computer, or other device having similar dimensions, similar interfaces may be utilized with other types of devices (e.g., mobile telephone, “smart phone,” etc.) discussed herein and modified accordingly (e.g., for screen size, input device compatibly, ease of use, etc.). Note that the portion of the displays described herein may be labeled differently and not necessarily as shown.

In some embodiments, an authenticated or non-authenticated customer (e.g., operating a customer computing entity 110/120) may access the retailer system (e.g., shopping online via the retailer) and browse one or more items for purchase. For example, displays 900-915 of FIGS. 9A-9E, respectively, show a process for using a retailer website to make a purchase of a product. As is shown, FIG. 9A shows a display 900 screen that may be displayed by a device with which an item may be viewed and purchased, by for example, selecting “Add to Cart.” FIG. 9B shows a display 905 that may be displayed after selection of “Add to Cart,” particularly showing the “cart,” the “cart” comprising the selected item, a corresponding quantity and price as well as, in some embodiments, any other previously selected items and/or information/data indicative of items that may have been removed, prices changes, or the like. Furthermore, display 1905 may configured such that items in the cart may be purchased by selecting “Proceed to Checkout.”

A retailer system/third party system 125 (e.g., in communication with customer computing entities 110/120 and/or carrier systems 100), as is shown in operation 805, may include means, such as processor 205 or the like, for, determining the location of the customer. That is, location may be determined, because, in some embodiments, benefits, such as one or more delivery windows available for selection, may be provided. For example, location may be determined via customer entered data, customer profile data, and/or using the IP address or GPS functionality of the customer computing entity. For example, FIG. 9C shows a display 910 that may be displayed by the retail system requesting an email address enabling the customer to sign into the retailer's secure server, the secure server storing customer profile data or the like, enabling the retail system 125 to determine the location of the customer. Additionally or alternatively, in some embodiments, location may be requested. FIG. 10 shows a display 1000 that may be presented by the retailer system/third party system 125 to a customer (e.g., operating a customer computing entity 110/120) displaying a pop-up window requesting customer location information/data (e.g., a zip code). In some embodiments, the retailer system may determine the customer's location before, during, or subsequent to selection of item, placement of an item in a shopping cart, a checkout process, shipping of the item or the like in order provide potential and/or available delivery windows to the customer. Whereas, in other embodiments, location may be determined later. Moreover, in some embodiments, retailer system/third party system 125 may include means, such as processor 205 or the like, for determining the authentication of a customer for providing one or more additional benefits to those consumers that are determined to be authenticated and, in some embodiments, those consumers who elect to receive and/or selecting windows, or in some embodiments, access points, and, as such, may be temporarily enrolled in the authentication process.

Returning to FIG. 8, as customers browse for items to purchase, the retailer system may use the customer location to determine if inventory of the items displayed to the customer are available near the customer location. That is, in some embodiments, the retailer system/third party system 125, as is shown in operation 810, may include means, such as processor 205 or the like, for, determining whether an item (e.g., a currently displayed item) is available for delivery to the customer location. For example, in some embodiments, the retailer system/third party system 125 may be configured to determine if the item is located within a predetermined distance of the location of the customer. For example, the retailer system/third party system 125 may determine whether inventory exists for an item (e.g., a clothing item) at a warehouse, retail location, and/or the like within the same geographic region (e.g., city, zip code, range of zip codes, geo-fenced area) or the like. In some embodiments, the retailer system/third party system 125 (e.g., in communication with customer computing entities 110/120 and/or carrier systems 100), as is shown in operation 815, may include means, such as processor 205 or the like, for querying or otherwise providing a request to, for example, the carrier system 100, to determine which time frames delivery may be available. In some embodiments, the retailer system/third party system 125 may request if delivery is available within one or more predetermined time frames (e.g., 1 pm-3 pm, within 8 hours, within 24 hours, next day). In some embodiments, retailer system/third party system 125 may include means, such as processor 205 or the like, for determining eligibility for delivery within specific time frames. The retailer system/third party system 125 (e.g., in communication with customer computing entities 110/120 and/or carrier systems 100), as is shown in operation 820, may include means, such as processor 205 or the like, for, receiving from, for example carrier system 100, notification or communication regarding the availability of delivery options. That is, the carrier system 100 may include means for optimizing delivery logistics, including but not limited to pick-up times, driver selection, route optimization, etc.

In some embodiments, a retailer system/third party system 125 and a carrier system 100 may have established rules for delivery within predetermined time frames. For example, delivery within 24 hours may be available for orders within a given geographic area and/or received by a predetermined and/or agreed upon time. In some embodiments, the given geographic area and/or the predetermined time may be item dependent. For example, items under a certain weight (e.g., 25 lbs.) may be available for same day/time compressed delivery if ordered by a certain time (e.g., 2 pm). In this case, retailer system/third party system 125, as is shown in operation 1825, may include means, such as processor 205 or the like, for, determining eligibility for a given order without having to contact the carrier system 100. In some embodiments, retailer system/third party system 125 may be configured to store one or more, or in some embodiments, each of the established rules locally (e.g., database 240), and as such, need not query carrier system 100 in the determination of which of one or more time frames may be available for delivery.

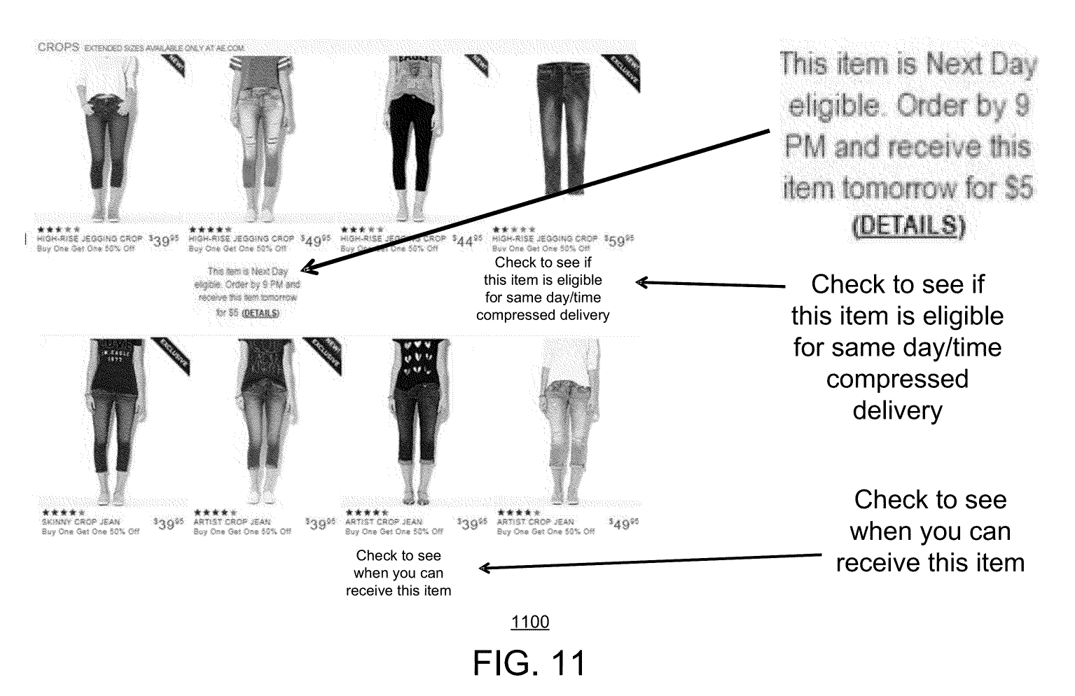

Using the response from the carrier system 100 related to inventory and/or delivery availability and/or data/information from the established rules related to inventory and delivery availability, retailer system/third party system 125 (e.g., in communication with customer computing entities 110/120 and/or carrier systems 100), as is shown in operation 1830, may include means, such as processor 205 or the like, for, providing an indication that delivery of the item is available for delivery within one or more predetermined time frames. For example, in some embodiments, as shown in FIG. 11, the retailer system/third party system 125 may provide or present a display, (e.g., display 1100), indicating that delivery by the next day is available (e.g., “This item is Next Day eligible”, “Check to see if this item is eligible for same day/time compressed delivery”, “Check to see when you can receive this item”, or the like) before an item is purchased and while the customer is still browsing. In other embodiments, the retailer system/third party system 125 may display one or more delivery options (e.g., “FREE standard shipping, FREE Two-Day Shipping, $3.99 One-Day Shipping, or the like) and/or one or more delivery windows (e.g., 8 AM to 10 AM, 1 PM to 3 PM, 3 PM to 5 PM) related to an item or items in the cart that the customer is viewing and/or has indicated an intent to purchase by selecting “Proceed to Checkout,” as shown in display 915 of FIG. 9D. As shown display 9D may be displayed after the customer has signed in and optionally may be configured to display the customer's shipping address, payment method, and billing address. Note that the shipping address, the payment method, and billing address each may be edited and/or changed. Each delivery option and each delivery window may be configured for selection by, for example, clicking on the selectable icon next to the desired option. FIG. 19E shows display 920 that may be displayed after selection of “Place Your Order” and confirms the selected delivery option.

In some embodiments, the retailer system/third party system 125 and/or carrier system 100 may impose, or otherwise require a fee for each of one or more delivery options and/or access points. In some embodiments, the current time of the day, the current day of the week or the like may affect the availability and/or fee of each of one or more predetermined delivery time frames or delivery windows and/or access points. In some embodiments, the retailer system/third party system 125 may include one or more business rules requiring receipt of an order by a certain time to confirm and/or facilitate delivery of the item within the estimated delivery time or access point.

FIG. 12 shows a diagram illustrating street segments utilized in part to generate one or more logistics zones. In the example embodiment of FIG. 12, the carrier/transporter computing entity 100 may analyze the street segments such as 1st street, 2nd street, A-Avenue and B-Avenue to define logistics zones. The street segments such as 1st street, 2nd street, A-Avenue and B-Avenue may include segments and nodes (e.g., nodes 43, 45, 47, 49) and may be associated with street segment attributes and/or definitions data. In some embodiments, the carrier/transporter computing entity 100 may generate logistics zones that are offset a distance (e.g., 200 feet) from street segments (e.g., 1st street, 2nd street, A-Avenue and B-Avenue). For instance, in the example embodiment of FIG. 8, the carrier/transporter computing entity 100 may generate logistics zones 55, 57, 59, 61, 63, 65, 67, 69, 71, 73, 75, 77, 79, 81, 83, 85, 87, 89, 91, 93, 95, 97, 99, 101 and 103 that may be offset from a distance (e.g., 200 feet) from respective street segments. The carrier/transporter computing entity 100 may generate one or more unique handling instructions (e.g., human readable handling instructions) and codes for one or more of the logistics zones. The handling instructions may include data specifying items for pick-up and/or delivery at addresses in corresponding logistics zones.

In some example embodiments, the carrier/transporter computing entity 100 may facilitate grouping of time-compressed logistics zones (e.g., logistics zones 61, 63, 65 and 67) together to form larger logistics zones or pick-up, meet points, delivery areas. In this manner, the carrier/transporter computing entity 100 may group information together to enhance a dispatch process. For instance, the carrier/transporter computing entity 100 may generate a dispatch plan for the larger group of logistics zones. As logistics zones are grouped together by the carrier/transporter computing entity 100, the carrier/transporter computing entity 100 may assign a particular sequence that provides information regarding the order in which logistics zones of the group of logistics zones are assigned for pick-up and/or delivery of items.

### 4. Use Cases

### A. Exemplary Use Case 1: Pick Up Item by Midnight and Deliver Next Morning

The following use case describes a user (e.g., operating a user computing entity 110) triggering/initiating the physical shipment of one or more items by providing an electronic message/notification via, for example, a user computing entity 110, a payment computing entity 115, a retailer computing entity 120, a social media computing entity 125, or the like (e.g., on Day 0), the electronic message/notification comprising or otherwise associated with a time frame/window indicating a request for delivery by the next morning (e.g., Day 1).

For example, a consignee may order one or more items (e.g., a product) on-line at or before, for example, 12:00 AM (midnight) and may be interested in having the one or more items delivered quickly. The retailer or 3rd party carrier/transporter company may determine if the item(s) are in stock at, for example, a local store and/or distribution center. The retailer or 3rd party carrier/transporter company may then identify or determine a location and/or multiple locations of local store(s) and/or distribution center(s) at which the item(s) are available and provide that information to a carrier. The carrier/transporter may then determine optimized, or near optimized, shipping options, including, for example, pick-up locations as well as the capability to provide next-day delivery (e.g., Time Compressed Delivery) and provide a response to the retailer and/or directly to the consumer. The retailer may then inform the consignee (e.g. the consumer) that the product is in-stock and available for, for example, time compressed/sensitive delivery by, again for example, 8:00 am the next morning. The consignee may then confirm the need, or in some embodiments, acceptance of conditions for, time compressed/sensitive delivery or, in other embodiment, select another delivery option. The retailer may then prepare an item for shipping, including the product and a shipping label (e.g., package level detail (PLD)) or, in some embodiments, opts for carrier/transporter controlled shipping. A carrier/transporter may then pick up the item from the retailer, or other designated location (e.g., local store/distribution center), that night (e.g., at or around mid-night). The carrier/transporter may then move the item to a carrier/transporter sorting facility and/or a driver for early (e.g., 8:00 a.m.) delivery.

Here, a carrier/transporter and/or carrier/transporter company provides a solution enabling consignees to receive items the next day after placing an order with the retailer. The routing optimization may include (1) determining whether the carrier/transporter can make the time compressed/sensitive delivery by, for example, reviewing current vehicle locations and routes; (2) dynamically optimizing multiple drivers routes including (i) dynamically optimizing one or more vehicle routes to pick up an item the same evening (e.g., by midnight); (ii) dynamically optimizing one or more vehicle routes to related to movement among or across item sorting locations; and (iii) dynamically optimizing one or more vehicle routes to coordinate meet points for same day delivery.

### B. Exemplary Use Case 2: Pick Up Item in Morning and Delivery Same Morning

The following use case describes a user (e.g., operating a user computing entity 110) triggering/initiating the physical shipment of one or more items by providing an electronic message/notification (e.g., the morning of Day 1), the electronic message/notification comprising or otherwise associated with a time frame/window indicating a request for delivery the same day (e.g., Day 1).

For example, a consignee may order one or more items (e.g., a product) on-line at or before, for example, morning (e.g., at or before 8 a.m.) and may be interested in having the one or more items delivered quickly. The retailer or 3rd party carrier/transporter company may determine if the item(s) are in stock at, for example, a local store and/or distribution center. The retailer or 3rd party carrier/transporter company may then identify or determine a location and/or multiple locations of local store(s) and/or distribution center(s) at which the item(s) are available and provide that information to a carrier. The carrier/transporter may then determine optimized, or near optimized, shipping options, including, for example, pick-up locations as well as the capability to provide same-day delivery (e.g., Time Compressed Delivery) and provide a response to the retailer and/or directly to the consumer. The retailer may then inform the consignee (e.g. the consumer) that the product is in-stock and available for, for example, time compressed/sensitive delivery by, for example, 10:30 a.m. in the morning. The consignee may then confirm the need, or in some embodiments, acceptance of conditions for, time compressed/sensitive delivery or, in other embodiments, select another delivery option. The retailer then prepares an item for shipping, including the product and a shipping label (e.g., PLD) or, in some embodiments, opts for carrier/transporter controlled shipping. A carrier/transporter may then pick up the item from the retailer, or other designated location (e.g., local store/distribution center), that morning (e.g., by 8 a.m.). The carrier/transporter may then move the item to a carrier/transporter sorting facility and/or a driver for early (e.g., 10:30 a.m.) delivery.

Here, the carrier/transporter provides a solution enabling consignees to receive items within hours of placing an order with the retailer. The routing optimization may include (1) determining whether the carrier/transporter can make the time compressed/sensitive delivery by, for example, reviewing current vehicle locations and routes; (2) dynamically optimizing multiple drivers routes including (i) dynamically optimizing one or more vehicle routes to pick up an item in the morning (e.g., by 8:00 a.m.); (ii) dynamically optimizing one or more vehicle routes to identify or otherwise create one or more meet points and/or one or more meet times; and (iii) dynamically optimizing one or more vehicle routes to deliver item the same day (e.g., by, for example, 10:30 a.m.).

C. Exemplary Use Case 3: Pick Up Item and Deliver within Hours

The following use case describes a user (e.g., operating a user computing entity 110) triggering/initiating the physical shipment of one or more items by providing an electronic message/notification (e.g., on Day 1), the electronic message/notification comprising or otherwise associated with a time frame/window indicating a request for delivery by the same day (e.g., Day 1).

For example, a consignee may order one or more items (e.g., a product) on-line at or before, for example, late morning or early afternoon (e.g., around 12:00 PM or noontime) and may be interested in having the one or more items delivered quickly. The retailer or 3rd party carrier/transporter company may determine if the item(s) are in stock at, for example, a local store and/or distribution center. The retailer or 3rd party carrier/transporter company may then identify or determine a location and/or multiple locations of local store(s) and/or distribution center(s) at which the item(s) are available and provide that information to a carrier. The carrier/transporter may then determine optimized, or near optimized, shipping options, including, for example, pick-up locations as well as the capability to provide same-day delivery (e.g., Time Compressed Delivery) and provide a response to the retailer and/or directly to the consumer. The retailer may then inform the consignee (e.g. the consumer) that the product is in-stock and available for, for example, time compressed/sensitive delivery by, for example, early, mid, or late afternoon. The consignee may then confirm the need, or in some embodiments, acceptance of conditions for, time compressed/sensitive delivery or, in other embodiments, select another delivery option. The retailer then prepares an item for shipping, including the product and a shipping label (e.g., PLD) or, in some embodiments, opts for carrier/transporter controlled shipping. A carrier/transporter may then pick up the item from the retailer, or other designated location (e.g., local store/distribution center), that day (e.g., by early afternoon, 12:30 p.m. or the like). The carrier/transporter may then move the item to a carrier/transporter sorting facility and/or a driver for early, mid, or late afternoon delivery.

Here, again, the carrier/transporter provides a solution enabling consignees to receive items within hours of placing an order with the retailer. The routing optimization may include (1) determining whether the carrier/transporter can make the time compressed/sensitive delivery by, for example, reviewing current vehicle locations and routes; (2) dynamically optimizing multiple drivers routes including (i) dynamically optimizing one or more vehicle routes to pick up an item in the late morning or early afternoon (e.g., by 12:30 p.m.); (ii) dynamically optimizing one or more vehicle routes to identify or otherwise create one or more meet points and/or one or more meet times; and (iii) dynamically optimizing one or more vehicle routes to deliver item the same day (e.g., by, for example, mid to late-afternoon).

### D. Exemplary Use Case 4: Shipment Initiated by Shipper (e.g., Retailer) to Determine if Same-Day Delivery can be Executed

The following use case describes a retailer (e.g., operating a retailer computing entity 120) triggering/initiating the physical shipment of one or more items by providing an electronic message/notification on Day 1 with a time frame/window as part of the electronic message/notification indicating delivery by the same day, Day 1.

For example, a consignee may place an order for a product on-line on a retailer's web site, for example, any day and may be looking to get item delivered quickly. Or, in another embodiment, a consignor, such as a repair shop, dry cleaners, grocery store, or the like, may desire to have one or more items, such as a repaired tennis racquet, dry-cleaned clothes, or groceries, delivered to a consignee quickly. The retailer or 3rd party carrier/transporter company may determine if item is in stock at a local store or distribution center or otherwise determine if the one or more items are ready for shipment. The retailer or 3rd party carrier/transporter company may then determine a location and/or multiple locations of store(s)/distribution center(s) where the product is available and provide that information to the carrier. The carrier/transporter may then determine optimized, or near optimized, shipping options based on, for example, planned route(s) of regular vehicle(s) in the area and/or locations for pick-up available including capability to provide same-day delivery (e.g., Time Compressed Delivery) and provide a response to the retailer, who may or may not be a regular client/user of the carrier. The retailer may then inform the consignee (e.g. the consumer) that the product is in-stock and available for, for example, time compressed/sensitive delivery the same day. The consignee may then confirm the need, or in some embodiments, acceptance of conditions for, time compressed/sensitive delivery or, in other embodiments, select another delivery option. The retailer then prepares an item for shipping, including the product and a shipping label (e.g., PLD) or, in some embodiments, opts for carrier/transporter controlled shipping. A carrier/transporter may then pick up the item from the retailer, or other designated location (e.g., local store/distribution center), that day during normal pick-up/delivery times planned or scheduled for that day. The carrier/transporter may then move the item directly to the consignee during the vehicle's completion of the planned route for that day (e.g., the item is not taken to a carrier/transporter sorting facility).

Here, the carrier/transporter provides a solution enabling consignees to receive items the same day of placing an order with the retailer. The process may include (1) determining whether the carrier/transporter can make the time compressed/sensitive (e.g., same-day) delivery by, for example, (i) reviewing current vehicle locations and routes; (ii) determining whether pick-up and delivery can be made during a vehicle's planned route; and (iii) creating a pick-up point and delivery point to execute same-day delivery; (2) dynamically optimizing a single vehicle route; (3) utilizing logistics zones to determine if the execution of same-day delivery, including the pick-up and delivery of the item, is within a predetermined tolerance; (4) utilizing synchronized delivery system to determine if the execution of same-day delivery, including the pick-up and delivery of the item, is within a predetermined tolerance.

E. Exemplary Use Case 5: Shipment Initiated by Consignee (e.g. Consumer) to Determine if Same-Day Delivery can be Executed

The following use case describes a user (e.g., operating a user computing entity 110) triggering/initiating the physical shipment of one or more items by providing an electronic message/notification on Day 1 with a time frame/window as part of the electronic message/notification indicating delivery by the same day, Day 1.

For example, a consumer determines that they would like to ship an item to a local consignee for same-day delivery. A carrier/transporter company (e.g., UPS) may then determine a location for pick-up and provide that information to the consumer. The carrier/transporter may then determine optimized, or near optimized, shipping options based on, for example, planned route(s) of regular vehicle(s) in the area and/or locations for pick-up available including capability to provide same-day delivery (e.g., Time Compressed Delivery) and provide a response to the consumer, who may or may not be a regular client/user of the carrier. The consumer may then inform the consignee that the product is schedule for, for example, same-day delivery. The consumer then prepares an item for shipping, including the product and a shipping label (e.g., PLD) or, in some embodiments, opts for carrier/transporter controlled shipping. A carrier/transporter may then pick up the item from the consumer that day during normal pick-up/delivery times planned for that day. The carrier/transporter may then move the item directly to the consignee during the vehicle's completion of the planned route for that day (e.g., the item is not taken to a carrier/transporter sorting facility).

Here, the carrier/transporter provides a solution enabling consumer to ship items for delivery to the consignee the same-day. The process may include (1) determining whether the carrier/transporter can make the time compressed/sensitive (e.g., same-day) delivery by, for example, (i) reviewing current and planned vehicle locations, drivers, routes and sorts; (ii) determining whether pick-up and delivery can be made during a vehicle's planned route; and (iii) creating a pick-up point and delivery point (e.g., meet points) to execute same-day delivery; (2) dynamically optimizing a single vehicle route; (3) utilizing time-compressed logistics zones to determine if the execution of time-compressed or same-day delivery, including the pick-up and delivery of the item, is within a predetermined tolerance; (4) utilizing synchronized delivery system (SDS) including, for example, match and proximity SDS to determine if the execution of same-day delivery, including the pick-up and delivery of the item, is within a predetermined tolerance (e.g. costs, distance, time, weather, etc.).

### F. Exemplary Use Case 6: Shipment Initiated by Shipper (e.g., Local Store Owner) to Determine if Same-Day Delivery can be Executed by Driver Making Delivery at Local Store

The following use case describes a retailer (e.g., operating a retailer computing entity 120) triggering/initiating the physical shipment of one or more items by providing an electronic message/notification on Day 1 with a time frame/window as part of the electronic message/notification indicating pick-up by the vehicle and/or driver performing their planned route and delivery within a time-compressed (e.g., the same day, Day 1) time frame.

For example, a consignee, while shopping or browsing on a retailer's web site or the like, may inquire or otherwise indicate a desire to know whether a product is available for time-compressed delivery. The retailer or 3rd party carrier/transporter company may determine if item is in stock at a local store or distribution center. The retailer or 3rd party carrier/transporter company may then determine a location and/or multiple locations of store(s)/distribution center(s) where the product is available and provide that information to the carrier. The carrier/transporter may then determine whether pick-up can be made on, for example, the planned route of the vehicle or driver, or in some embodiments, on an optimized, or near optimized route based on, for example, planned route(s) of regular vehicle(s) in the area and provide a response to the retailer, who may or may not be a regular client/user of the carrier. The retailer may then inform the consignee (e.g. the consumer) that the product is in-stock and available for, for example, time compressed/sensitive delivery the same day. The consignee may then place the order and/or confirm the need, or in some embodiments, acceptance of conditions for, time compressed delivery or, in other embodiments, select another delivery option. The retailer then prepares an item for shipping, including the product and a shipping label (e.g., PLD) or, in some embodiments, opts for carrier/transporter controlled shipping. A carrier/transporter may then pick up the item from the retailer, or other designated location (e.g., local store/distribution center), that day during normal pick-up/delivery times planned or scheduled for that day. The carrier/transporter may then move the item directly to the consignee during the vehicle's completion of the planned route for that day (e.g., the item is not taken to a carrier/transporter sorting facility), or in some embodiments, perform the actions described above with reference to FIG. 4, such as for example, determining whether a need exists for multiple delivery vehicles and/or delivery routes to pick up the one or more items at one of the one or more pick-up locations and deliver the one or more items to one of the one or more delivery locations within the time frame/window, and where a single vehicle, for example, operating on a planned route, may not be able to pick up the one or more items at the one of the one or more pick-up locations and deliver the one or more items to one of the one or more delivery locations within the time frame/window, dynamically identify, create, insert or the like, meet-up points and/or meet-up times in the planned routes of one or more available vehicles to execute, for example, same-day, delivery.

In another embodiment of this use case, once the consignee inquires of the availability of time-compressed delivery, the retailer or 3rd party carrier/transporter company may determine that the item is not in stock at a local store or distribution center. The carrier/transporter or, in some embodiments, the retailer or 3rd party carrier/transporter company may contact a second retailer or the like, to determine a location and/or multiple locations of store(s)/distribution center(s) where the product is available. The carrier/transporter, after receiving information regarding one or more locations (e.g., not local to the consignee) that the one or more items is available, may then determine whether pick-up can be made on, for example, any route of a vehicle or driver, or in some embodiments, on an optimized, or near optimized route based on, for example, planned route(s) of regular vehicle(s) in the area of the pick-up location and provide a response to the retailer, who may or may not be a regular client/user of the carrier. That is, for example, if a consignee in Atlanta inquires on the availability of time-compressed delivery of a, for example, designer watch, and retailer system determines that the designer watch is not available, at for example, the local store and/or distribution center, the carrier/transporter calculate and/or determine whether delivery can be made according to the process of FIG. 4. For example, the carrier/transporter may determine whether the one or more items can be picked up at one of the one or more pick-up locations and delivered to one of the one or more delivery locations within the time window based on one or more of (1) available delivery vehicles, (2) available delivery drivers, (3) planned routes, (4) physical vehicle capacity, (5) planned sort capabilities, (6) available meet points, (7) available pick-up times, or the like.

It should be pointed out that FIGS. 4 and 8 are flowcharts of a system, method and computer program product according to an example embodiment of the invention. It will be understood that each block of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., volatile memory 215, non-volatile memory 210, volatile memory 322, non-volatile memory 324) and executed by a processor (e.g., processing element 205, processing device 308). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart blocks.

Accordingly, blocks of the flowchart support combinations of means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In an example embodiment, an apparatus for performing the method of FIGS. 4 and/or 8 above may comprise a processor (e.g., processing element 205, processing device 308) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing the operations may comprise, for example, the processing element 205 (e.g., a processor) (e.g., as means for performing any of the operations described above), the processing device 308 and/or a device or circuitry for executing instructions or executing an algorithm for processing information as described above.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
receiving an electronic notification, the electronic notification indicative of a prospective shipment of one or more items, the electronic notification comprising (1) one or more pick-up locations, each indicative of a location that the one or more items are available for pick-up; (2) one or more delivery locations, each indicative of a location at which the one or more items may be delivered; and (3) a time window;
determining whether the one or more items can be picked up at one of the one or more pick-up locations and delivered to one of the one or more of delivery locations within the time window based on one or more of: available delivery vehicles, available delivery drivers, planned routes, physical vehicle capacity, planned sort capabilities, available meet points, and available pick-up times; and
in an instance in which it is determined that the one or more items can be picked up at one of the one or more pick-up locations and delivered to one of the one or more delivery locations within the time window, providing an affirmative response to the electronic notification, the affirmative response indicating that the one or more items can be picked up at one of the one or more pick-up locations and delivered to one of the one or more delivery locations within the time window.

2. The method according to claim 1, wherein the determination of whether the one or more items can be picked up at one of the one or more pick-up locations and delivered to one of the one or more delivery locations within the time window comprises:
calculating and determining if at least one vehicle and at least one route can be utilized to pick up one or more items at one of the one or more pick-up locations and deliver the one or more items to one of the one or more delivery locations within the time window.

3. The method according to claim 1, further comprising:
determining whether a need exists for multiple delivery vehicles and delivery routes to pick up one or more items at one of the one or more pick-up locations and deliver the one or more items to one of the one or more delivery locations within the time window.

4. The method according to claim 2, further comprising:
in an instance in which a single delivery driver and single delivery route is needed, optimizing the single delivery route to pick up one or more items at one of the one or more pick-up locations and deliver the one or more items to one of the one or more delivery locations within the time window.

5. The method according to claim 2, further comprising:
in an instance in which two or more delivery vehicles are needed to pick up one or more items at one of the one or more pick-up locations and deliver the one or more items to one of the one or more delivery locations within the time window, calculating, for each of the two or more necessary vehicles, an associated delivery route, an associated pick-up time, and an associated pick-up location,
the pick-up location for a first vehicle being one of the one or more pick-up locations, the pick-up location for each subsequent driver being a drop-off location for a preceding vehicle, the drop-off location for a last vehicle being one of the one or more delivery locations.

6. The method according to claim 5, further comprising:
coordinating optimization of the associated delivery route of each of the two or more delivery vehicles to determine the associated pick-up time and pick-up location of each of the two or more delivery vehicles, the optimization of the determination being based on (1) existing item delivery constraints of the carrier system and each of the two or more delivery vehicles; and (2) route border limits of each delivery route.

7. The method according to claim 1, further comprising:
allowing a consignor to tender the one or more items at one or more specific time windows within a 24-hour period to facilitate the delivery of the one or more items within time window.

8. The method according to claim 1, further comprising:
providing an affirmative response providing a consignor multiple options to tender the one or more items at one or more specific time windows within a time period to facilitate delivery of the one or more items within the time window.

9. The method according to claim 1, further comprising:
calculating new routes for delivery vehicles using one or more of same day logistics zones, real-time telematics data and synchronized delivery system (SDS) information.

10. An apparatus comprising at least one processor and at least one memory including program code, the at least one memory and the program code configured to, with the processor, cause the apparatus to at least:
receive an electronic notification, the electronic notification indicative of a prospective shipment of one or more items, the electronic notification comprising (1) one or more pick-up locations, each indicative of a location that the one or more items are available for pick-up; (2) one or more delivery locations, each indicative of a location at which the one or more items may be delivered; and (3) a time window;
determine whether the one or more items can be picked up at one of the one or more pick-up locations and delivered to one of the one or more of delivery locations within the time window based on one or more of: available delivery vehicles, available delivery drivers, planned routes, physical vehicle capacity, planned sort capabilities, available meet points, and available pick-up times; and
in an instance in which it is determined that the one or more items can be picked up at one of the one or more pick-up locations and delivered to one of the one or more delivery locations within the time window, provide an affirmative response to the electronic notification, the affirmative response indicating that the one or more items can be picked up at one of the one or more pick-up locations and delivered to one of the one or more delivery locations within the time window.

11. The apparatus of claim 10, wherein the memory and program code for the determination of whether the one or more items can be picked up at one of the one or more pick-up locations and delivered to one of the one or more delivery locations within the time window is further configured to, with the processor, cause the apparatus to:
calculate and determine if at least one vehicle and at least one route can be utilized to pick up one or more items at one of the one or more pick-up locations and deliver the one or more items to one of the one or more delivery locations within the time window.

12. The apparatus of claim 10, wherein the memory and program code is further configured to, with the processor, cause the apparatus to:
determine whether a need exists for multiple delivery vehicles and delivery routes to pick up one or more items at one of the one or more pick-up locations and deliver the one or more items to one of the one or more delivery locations within the time window.

13. The apparatus of claim 11, wherein the memory and program code is further configured to, with the processor, cause the apparatus to:
in an instance in which a single delivery driver and single delivery route is needed, optimize the single delivery route to pick up one or more items at one of the one or more pick-up locations and deliver the one or more items to one of the one or more delivery locations within the time window.

14. The apparatus of claim 11, wherein the memory and program code is further configured to, with the processor, cause the apparatus to:
in an instance in which two or more delivery vehicles are needed to pick up one or more items at one of the one or more pick-up locations and deliver the one or more items to one of the one or more delivery locations within the time window, calculate, for each of the two or more necessary vehicles, an associated delivery route, an associated pick-up time, and an associated pick-up location,
the pick-up location for a first vehicle being one of the one or more pick-up locations, the pick-up location for each subsequent driver being a drop-off location for a preceding vehicle, the drop-off location for a last vehicle being one of the one or more delivery locations.

15. The apparatus of claim 14, wherein the memory and program code is further configured to, with the processor, cause the apparatus to:
coordinate optimization of the associated delivery route of each of the two or more delivery vehicles to determine the associated pick-up time and pick-up location of each of the two or more delivery vehicles, the optimization of the determination being based on (1) existing item delivery constraints of the carrier system and each of the two or more delivery vehicles; and (2) route border limits of each delivery route.

16. The apparatus of claim 10, wherein the memory and program code is further configured to, with the processor, cause the apparatus to:
allow a consignor to tender the one or more items at one or more specific time windows within a 24-hour period to facilitate the delivery of the one or more items within time window.

17. The apparatus of claim 10, wherein the memory and program code is further configured to, with the processor, cause the apparatus to:
provide an affirmative response providing a consignor multiple options to tender the one or more items at one or more specific time windows within a time period to facilitate delivery of the one or more items within the time window.

18. The apparatus of claim 10, wherein the memory and program code is further configured to, with the processor, cause the apparatus to:
calculate new routes for delivery vehicles using one or more of same day logistics zones, real-time telematics data and synchronized delivery system (SDS) information.

19. A computer program product comprising at least one non-transitory computer-readable storage medium having computer-readable program code portions stored therein, the computer-readable program code portions comprising:
an executable portion configured to receive an electronic notification, the electronic notification indicative of a prospective shipment of one or more items, the electronic notification comprising (1) one or more pick-up locations, each indicative of a location that the one or more items are available for pick-up; (2) one or more delivery locations, each indicative of a location at which the one or more items may be delivered; and (3) a time window;
an executable portion configured to determine whether the one or more items can be picked up at one of the one or more pick-up locations and delivered to one of the one or more of delivery locations within the time window based on one or more of: available delivery vehicles, available delivery drivers, planned routes, physical vehicle capacity, planned sort capabilities, available meet points, and available pick-up times; and
an executable portion configured to, in an instance in which it is determined that the one or more items can be picked up at one of the one or more pick-up locations and delivered to one of the one or more delivery locations within the time window, provide an affirmative response to the electronic notification, the affirmative response indicating that the one or more items can be picked up at one of the one or more pick-up locations and delivered to one of the one or more delivery locations within the time window.

20. The computer program product claim 19 further comprising: wherein the executable portion configured to determine whether the one or more items can be picked up at one of the one or more pick-up locations and delivered to one of the one or more delivery locations within the time window comprises:
an executable portion configured to calculate and determine if at least one vehicle and at least one route can be utilized to pick up one or more items at one of the one or more pick-up locations and deliver the one or more items to one of the one or more delivery locations within the time window.

21. The computer program product claim 19 further comprising
an executable portion configured to determine whether a need exists for multiple delivery vehicles and delivery routes to pick up one or more items at one of the one or more pick-up locations and deliver the one or more items to one of the one or more delivery locations within the time window.

22. The computer program product claim 20 further comprising
an executable portion configured to, in an instance in which a single delivery driver and single delivery route is needed, optimize the single delivery route to pick up one or more items at one of the one or more pick-up locations and deliver the one or more items to one of the one or more delivery locations within the time window.

23. The computer program product claim 20 further comprising
an executable portion configured to, in an instance in which two or more delivery vehicles are needed to pick up one or more items at one of the one or more pick-up locations and deliver the one or more items to one of the one or more delivery locations within the time window, calculate, for each of the two or more necessary vehicles, an associated delivery route, an associated pick-up time, and an associated pick-up location,
the pick-up location for a first vehicle being one of the one or more pick-up locations, the pick-up location for each subsequent driver being a drop-off location for a preceding vehicle, the drop-off location for a last vehicle being one of the one or more delivery locations.

24. The computer program product claim 23 further comprising
an executable portion configured to coordinate optimization of the associated delivery route of each of the two or more delivery vehicles to determine the associated pick-up time and pick-up location of each of the two or more delivery vehicles, the optimization of the determination being based on (1) existing item delivery constraints of the carrier system and each of the two or more delivery vehicles; and (2) route border limits of each delivery route.

25. The computer program product claim 19 further comprising:
an executable portion configured to allow a consignor to tender the one or more items at one or more specific time windows within a 24-hour period to facilitate the delivery of the one or more items within time window.

26. The computer program product claim 19 further comprising:
an executable portion configured to provide an affirmative response providing a consignor multiple options to tender the one or more items at one or more specific time windows within a time period to facilitate delivery of the one or more items within the time window.

27. The computer program product claim 19 further comprising:
an executable portion configured to calculate new routes for delivery vehicles using one or more of same day logistics zones, real-time telematics data and synchronized delivery system (SDS) information.
